(19) United States
(12) Patent Application Publication
(10) Pub. No.: US 2020/0005468 A1
(43) Pub. Date: Jan. 2, 2020

(54) METHOD AND SYSTEM OF EVENT-DRIVEN OBJECT SEGMENTATION FOR IMAGE PROCESSING

(71) Applicant: Intel Corporation, Santa Clara, CA (US)

(72) Inventors: Somnath Paul, Hillsboro, OR (US); Turbo Majumder, Portland, OR (US); Mohamed Elmalaki, Gilbert, AZ (US); Muhammad Khellah, Tigard, OR (US); Charles Augustine, Hillsboro, OR (US)

(73) Assignee: Intel Corporation, Santa Clara, CA (US)

(21) Appl. No.: 16/565,304

(22) Filed: Sep. 9, 2019

(51) Int. Cl. G06T 7/215; G06K 9/00

(52) U.S. Cl. CPC G06T 7/215; G06K 9/00711; G06T 2207/10016; G06K 2009/00738; G06K 9/00986

(57) ABSTRACT

Methods, systems, and articles herein are directed to event-driven object segmentation to track events rather than tracking all pixel locations in an image.

### BACKGROUND

Many image processing applications use object segmentation to differentiate segment foreground objects from the background in the image and to differentiate between the segmented foreground objects. The segmented objects are then analyzed to be recognized and/or tracked. Some examples of such image processing applications are computer vision, monitoring, security, and/or surveillance camera systems that record video and use object segmentation in a process to recognize objects in the images.

Some conventional object segmentation processes use neural networks to establish a rough segmentation and/or to refine the edges of the segments. These neural network-based conventional object segmentation processes, however, typically require analysis of all pixels in an image which results in a very large computational load, and in turn, results in increased hardware costs and power consumption. In systems with high resolutions, the image data may be downscaled for object segmentation to increase performance but often at the cost of accuracy such that the amount of downscaled data may be insufficient to detect relatively small objects on an image.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of a conventional object recognition and tracking system;

FIG. 2 is a schematic diagram of a known full-frame object detection unit of the system of FIG. 1;

FIG. 3 is a flow chart of a method of event-driven object segmentation for image processing according to at least one of the implementations herein;

FIG. 4 is a schematic diagram of an event-driven object segmentation system according to at least one of the implementations herein;

FIG. 5 is a schematic diagram of another event-driven object segmentation system according to at least one of the implementations herein;

FIGS. 6A-6C is a detailed flow chart of a method of event-driven object segmentation for image processing according to at least one of the implementations herein;

FIG. 7 is a schematic logic diagram for an eventifier according to at least one of the implementations disclosed herein;

FIG. 8 is a schematic diagram showing a block sparse convolver 800 according to at least one of the implementations disclosed herein;

FIG. 8A is a schematic diagram of a convolution unit of FIG. 8;

FIG. 9 is a schematic diagram showing a region-of-interest generation unit according to at least one of the implementations disclosed herein;

FIG. 10A is an image of a previous frame in a video sequence;

FIG. 10B is an image of a subsequent frame in the video sequence of FIG. 10A;

FIG. 10C is a chart of clustered events for the images of FIGS. 10A-10B and according to at least one of the implementations disclosed herein;

FIG. 10D is a chart of convolved clusters for the images of FIGS. 10A-10B and according to at least one of the implementations disclosed herein;

FIG. 10E is a chart of connected components for the images of FIGS. 10A-10B and according to at least one of the implementations disclosed herein;

FIG. 10F is an image of resulting regions-of-interest for the images of FIGS. 10A-10B and according to at least one of the implementations disclosed herein;

FIG. 11 is a schematic diagram of an event-driven processing unit according to at least one of the implementations disclosed herein;

FIG. 12 is an illustrative diagram of an example system;

FIG. 13 is an illustrative diagram of another example system; and

FIG. 14 illustrates an example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes except for those architectures that are described herein. For instance, various architectures employing, for example, multiple integrated circuit (IC) chips and/or packages, and/or various computing devices, commercial devices, and/or consumer electronic (CE) devices such as imaging devices, digital video cameras, monitoring, security or surveillance cameras or camera networks, smart phones, webcams, video game panels or consoles, set top boxes, tablets, and so forth which may or may not be used for object segmentation tasks, and any of which may have light projectors and/or sensors for performing object detection, depth measurement, and other tasks, and may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof unless the content states otherwise.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Systems, articles, and methods to provide event-driven object segmentation for imaging processing are described below.

Real-time visual data processing such as for object recognition systems is crucial to several product segments. As an example, networked video recorders (NVR) are being developed to rapidly detect, classify, track, and analyze video data from many cameras at once. As the resolution of video frames increase, delivering this intelligence using traditional methods of video processing becomes more difficult to achieve within the constraints of limited memory bandwidth (BW), low latency, and energy-efficiency.

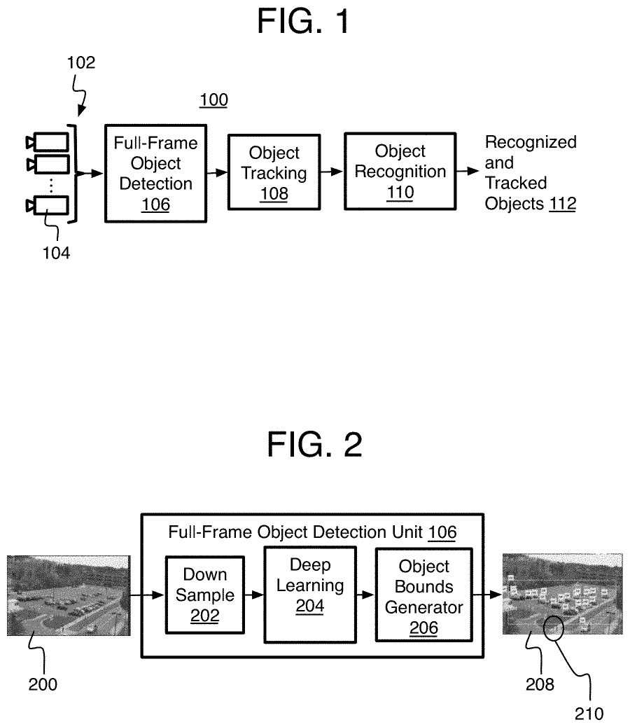

Referring to FIG. 1, such a conventional system 100 for object recognition has a camera array 102 with one or more cameras 104 that may record a scene being monitored. A full-frame object detection unit 106 receives the images from the cameras and detects objects in images frame by frame without using any temporal information at this point. The detected objects on each frame and from each camera are provided to an object tracking unit 108 that can track objects from frame to frame along a video sequence. An object recognition unit 110, whether tracked or not, classifies the detected objects to provide recognized and tracked objects 112. Once classified, a security system may identify unauthorized action in the images for example, and then trigger further automatic operations such as sounding alarms or alerting system owners or authorities. As mentioned, the full-frame object detection, however, has a number of disadvantages.

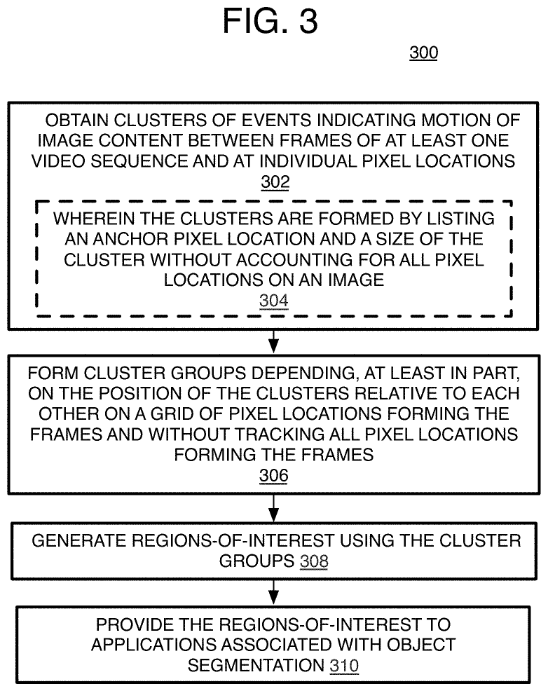

Referring to FIG. 2, the known full-frame object detection unit 106 receives image data of a sequence of high resolution images 200 and from multiple cameras. First, a down sample unit 202 down samples image data to limit the computational load and memory bandwidth requirements for the detector. The downsampled image data is then provided to a deep learning unit 204 frame by frame to perform foreground detection and background subtraction, which is a well-known computer vision (CV) problem. These foreground extractors involve learning the background image data using analytical and/or data-driven techniques. For these systems to learn the background, continuous learning is performed from all pixels in the frame. Some of the most popular deep learning (DL) based object detection algorithms include Fast-recurrent convolutional neural network (F-RCNN) which receives an entire image of data and defines regions on the image before refining the boundaries of the regions by an object bounds generator 206. Another technique that improves the F-RCNN is called “you only look once” (YOLO), although many other examples exist. YOLO also uses a deep learning unit 204 to input a full frame to a neural network that divides the input image into regions and predicts bounding boxes and probabilities for each region. For this operation, the bounding boxes may be refined by weighting them with the probabilities by the object bounds generator 206. The full-frame object detection unit 106 outputs frames 208 with detected regions of interest, which are then tracked from one frame to another, and recognized as mentioned above.

It has been found that for fixed cameras that are mainly monitoring for motion in the camera views, performing the full-frame computations and then only providing detected regions for classification and object recognition does not reduce the total computational load to perform the object detection and recognition. Instead, the deep learning analysis of the entire image including the background increases hardware cost, power, and performance overhead. Also, the compute and memory bandwidth requirements for the object detector increases quadratically with the resolution of the image and linearly with the number of video streams and the frames per second. Thus, working on all pixels of each frame creates a compute and memory bottleneck.

To compensate for the large computational load from inputting and segmenting an entire frame, the input frame is often downsampled as mentioned. The downsampling, however, leads to inaccuracy. For example, the moving pedestrians 210 in a parking lot in frame 208 are missed in the baseline scheme of the conventional full-frame object recognizer 100 (FIGS. 1-2).

One other solution uses event-based dynamic vision sensors (DVS) to improve computer vision and perform object recognition. The DVSs have specialized pixel-level circuitry for each pixel to immediately detect changes in electrical signals, and in turn in image data, at the pixel sensor level so that the camera sensors only need provide data when motion is detected at the pixel sensor thereby providing in-situ background subtraction. This can provide a significantly reduced image data size for each frame versus a full-resolution of image data. The DVS sensors, however, are limited in spatial resolution, consume high power, and have a large form factor due to the relatively large amount of the circuitry needed to detect motion at individual pixel sensors. Thus, this solution is unsuitable for integration into conventional neural network-based object recognition systems using conventional imaging sensors or cameras.

To resolve these issues, a system and method of event-driven object segmentation for image processing is used herein that identifies regions-of-interest (RoIs) in a scene based on motion saliency so that just the RoIs subsequently can be input to deep learning (DL) object detector neural networks rather than the image data of the full frame. Deep learning (DL) object detection may be part of an object tracking or object recognition pipeline. Thus, this leads to considerable savings in memory bandwidth (BW) and FLOPs (floating point operations per second) count for the DL workloads, which translates to better performance with lower power consumption.

This is accomplished by using an event-driven object segmentation method that generates the RoIs and that includes first detecting or generating events that indicate a change in pixel image data from frame to frame that meets at least one criterion that indicates saliency of motion at the pixel. The events are then clustered in a computational content-addressable memory (CCAM) depending on the temporal location (which frame in a video sequence for example) and spatial location of the events. Some forms of this event generation and clustering are described in detail in “Clustering Events in a Content Addressable Memory”, U.S. Patent Publication No. 2019/0043583 published on Aug. 23, 2018, which is incorporated herein in its entirety for all purposes. The resulting clusters of events are pixel locations indicating motion and that are closely located on a frame but are still too disjoint to identify any particular object because the clusters are usually too small. Accordingly, once the clusters are obtained, the clusters are convolved into coherent regions or cluster groups by analyzing the clusters rather than analyzing an entire frame of pixel data. These cluster groups, however, are still too rough to identify objects as well. Thus, a labeling operation, such as connected-component labeling (CCL) for example, is performed that differentiates the segments or objects into individual regions-of-interest (RoIs) and defines the boundaries of the RoIs. These RoIs can then be provided to object detection (or object segmentation refinement) algorithms such as a deep learning neural network object detection algorithm that either identifies the RoIs as segmented objects and/or groups the RoIs into segmented objects. Thereafter, the objects may be used by other algorithms that provide object recognition and/or object tracking for example. It should be noted that the term “pixel location” and “pixel” are used interchangeably to indicate a pixel position on a grid of pixels or an image, unless the context suggests otherwise. Likewise, the terms frame, image, and picture may be used interchangeably unless the context suggests otherwise.

Monitoring RoIs rather than the entire frame from frame to frame provides an event-driven approach that maintains a sparse and compact representation of the changes across frames, and therefore, the spatial and temporal correlations from frame to frame can be calculated on these changes alone while ignoring the data of the static or background pixels from frame to frame. This allows the power and performance to scale proportionally to the number of changes. Thus, with event-driven processing, the compute and memory BW requirements are no longer a function of the resolution, but instead scales with the activity in the scene so that image monitoring systems can rapidly detect, classify, track, and/or analyze video data from many cameras at once with high accuracy.

Such a system and method also allow for an improved architecture for performing event-driven processing, the power and performance of which significantly or completely scales with the number of events per changes in the scene as well. Thus, the entire or much of an event-driven processing unit (EPU) pipeline may be arranged such that the power and performance for event-driven RoI detection is also proportional to the events and/or activity in the scene. The proposed event-driven processing hardware and software accomplishes the same task as a DVS providing event data rather than entire frames, but at a much lower power per performance cost. The present event-based method allows event-driven operation with conventional (non-DVS) image or camera sensors and can work with multiple sensors (or cameras) at the same time. Thus, the present EPU can easily handle parallel object segmentation computations even though the EPU has a significantly smaller hardware capacity. This is possible because the data processing is event and RoI-based, as described herein. The EPU also can be easily integrated on known computer architecture such as SoCs for example.

Lastly, as an alternative, the event-driven processing unit also can work with a DVS camera, where an eventifier that computes events as described herein is bypassed or omitted. In this case, the events coming from event-detecting sensors of a DVS are clustered and used to segment objects in the same way as the events from the eventifier so that other than the eventifier, the rest of the EPU pipeline is the same for either event-generating technique.

It will be understood that such an object segmentation technique disclosed herein improves the computing device itself by using one or more event-driven processors to reduce the computational load on other processors as well as reduce delay and power consumption on a computing device not only by analyzing less than all pixels of a frame but also by enabling the implementation of event-driven power saving techniques described herein.

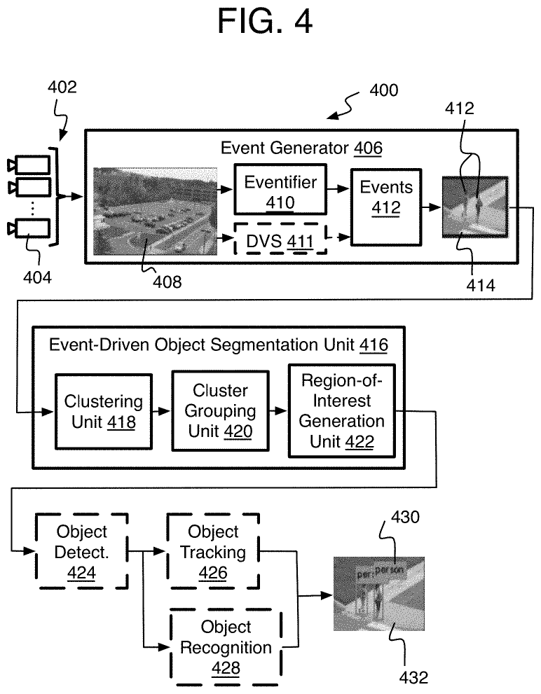

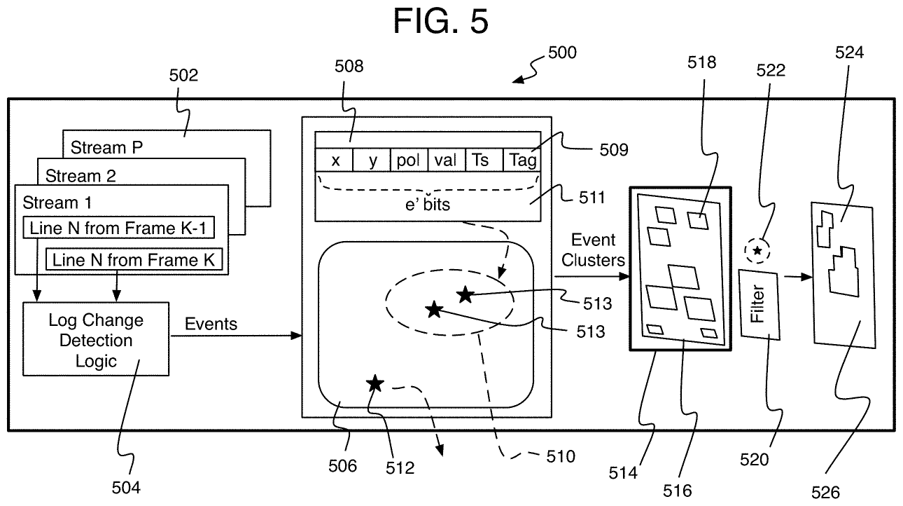

Referring to FIG. 3, a process 300 is provided for a method of event-driven object segmentation for imaging processing. In the illustrated implementation, process 300 may include one or more operations, functions or actions 302 to 310 numbered evenly. By way of non-limiting example, process 300 may be described herein with reference to example image processing systems or units 400, 500, 1100, or 1200 of FIGS. 4, 5, 11, and 12 respectively, and where relevant.

Process 300 may include “obtain clusters of events indicating motion of image content between frames of at least one video sequence and at individual pixel locations” 302. As mentioned, an event occurs when pixel image data, such as intensity, changes at a pixel sufficiently over time, and frame to frame, to meet a criterion, and therefore indicate salient motion. By one perspective, an event is a function of space and time which may be represented as spatial coordinates and timestamps. The events may be tracked without accounting for non-event pixels by providing a content addressable memory providing sparse representation that achieves compression by storing only valid or non-zero events.

To accomplish this event-related compression, the spatial and temporal data of an event is clustered by event coordinates within a same predefined range in a single entry in the memory. Thus, a list of clusters is formed in a memory or buffer. When an event is added to a cluster, the entry selected for clustering has coordinates, or other parameter values, that are within a predefined range of the parameter values in the event. In this way, a data set or frame having sparse changes to different regions of a frame or image have event information on the changed data clustered in a same entry when the coordinates for the events are spatially clustered. Events are also clustered temporally by selecting valid entries to add new events to clusters that have been in the memory for shorter than a purging time threshold, and purging or dropping entries that have been in memory for longer than a purging time threshold without any new events being added within the time threshold to update the cluster entry.

Events may be clustered at a spatial location that are temporally correlated as evidenced by several events within that cluster and a time window. By one example, this operation includes “wherein the clusters are formed by listing an anchor pixel location and a size of the cluster without accounting for all pixel locations on an image” 304, and without the need to list all of the pixel locations within the cluster. Such a listing also may have the time stamp (or frame) of each entry. The result is a listing of clusters by a computational content-addressable memory (CCAM) that is updated over time as frames of a video sequence are being analyzed. This technique is highly efficient for storing sparse events by avoiding space-time-volume-based storage or time series of spatial arrays that have large amounts of unutilized storage for non-event pixel locations. The CCAM adds clusters to its cluster list when a new event is not sufficiently near another event. In this case, a new cluster entry is started at a next empty field on the list and is listed on the cluster list in an order of the first event timestamp of the cluster. Each cluster entry on the cluster list also may have the anchor coordinate of the cluster, which is the pixel coordinate of the first event establishing the cluster. However, since the clusters are listed by time stamp, the result is that the cluster list of the CCAM lists the location of the clusters on an image randomly.

Process 300 may include “form cluster groups depending, at least in part, on the position of the clusters relative to each other on a grid of pixel locations forming the frames and without tracking all pixel locations forming the frames” 306. Forming the cluster groups initially may involve reordering the clusters onto a reverse mapping table since the cluster list does not have the clusters in location order. This is much more efficient since clusters are obtained in raster order for cluster grouping. The reverse mapping table also may list the proportion a cluster forms of a maximum cluster size by listing the area of the cluster such as 4×4 or 8×8 pixels when the maximum is 16×16 pixels for example. The method then may determine whether a current cluster being analyzed has neighbor clusters that are valid. Valid here refers to a valid cluster listed on the CCAM that has at least one or more events and that has been updated recently within a predetermined purge time. The cluster is fit within a maximum cluster size block, which is then placed in a patch array.

Neighbor clusters may be set in neighbor blocks on the patch array located by first setting a maximum cluster size around the anchor coordinates or location of the current cluster. The current and neighbor clusters with a size from the reverse mapping table that is smaller than the maximum size may be set at a random location within the current and neighbor block. By one form, the anchor coordinate of all of the clusters are set at the upper left corner of the block so that the cluster extends horizontally to the right and vertically downward from that corner and to provide uniformity in the results from all cluster groups loaded onto a patch array. By one form, this establishes a 3×3 or 5×5 neighborhood of maximum cluster size blocks.

While providing relatively cohesive areas of motion, the cluster groups still are not large enough to indicate object segments. Thus, the cluster groups are eventually formed into regions-of-interest (RoI). This is performed on a pixel by pixel level. In order to provide a pixel-level pipeline to an ROI generator, the cluster group is convolved to provide pixel-level convolutional sums that represent the cluster group. When at least one neighbor of a valid current cluster also is valid, this establishes a cluster group that is to be convolved. The convolution may be performed by loading the cluster group into the patch array and traversing a filter, such as a unity filter, over the patch to provide each pixel in the cluster group with a set of filter values that are accumulated to form a pixel-level convolutional sum. By one example form, this may be performed by using a single convolutional layer without using any other neural network layers. Thus, by this example form, this convolving operation is not a deep learning algorithm since no other weights are used and refined with use, and the convolving operation is not a deep neural network since only a single layer is used, making the accumulating operation extremely efficient and able to be processed on a simple multiply-accumulate (MAC) circuit. This has some similarity to a dilation operation in computer vision. The difference, however, is that convolution here results in a non-binary output which represents a much higher region of cohesive motion versus regions with random events. The convolved output when thresholded clearly demarcates regions with motion saliency.

Process 300 may include “generating regions-of-interest comprising using the cluster groups” 308. Particularly, this operation first may include determining whether the convolutional sum of a pixel location meets at least one criterion, such as being over a threshold. This indicates that the cluster group around the current pixel being analyzed occupies some minimum amount of pixel space around the current pixel. Since the convolutional sum factors multiple clusters for at least some pixel locations (by the filter overlapping two adjacent clusters), the greater the convolutional sum, the greater the likelihood that the motion is cohesive between clusters in the cluster group around the current pixel and in turn, the greater the likelihood that the grouping of clusters in the cluster group is accurate to represent a single object. This operation is repeated until an entire cluster is loaded onto a label array, and the loading proceeds cluster by cluster.

Those pixel locations with convolutional sums that pass the threshold are then initially labeled with a one for example, and on a label array. All other spaces on the label array are labeled with zero. Thus, this results in an object segmentation method that drops any non-event pixel location, invalid clusters, and clusters with pixels that do not pass the cluster area threshold, so that these 0 pixel locations are not tracked (data is not saved and analyzed for object segmentation for these locations), thereby significantly reducing the computational load to generate the regions-of-interest.

Thereafter, a label updating strategy, such as connected-component labeling (CCL), is applied with heuristic rules to modify the label of the valid and thresholded pixel locations on the label array. The rules modify a label pixel depending on the label of previously modified neighbor pixels. By one form, just the left and upper neighbor pixels are used. To accomplish this, whenever a cluster is to be an upper neighbor cluster to a subsequent current cluster, the method places the label of the bottom-most pixel location of each pixel column in the upper cluster into a label history table to store those bottom-most labels. The bottom-most labels can subsequently be used as the upper neighbor label for the pixel locations on the top-most pixels of the subsequent cluster. In addition, label update logic updates an RoI association table that records the RoI locations and size over time. Each time a pixel receives an updated label, the association table updates the RoI by adding the position of that pixel location to the appropriate RoI depending on its label.

Process 300 may include “provide the regions-of-interest to applications associated with object segmentation” 310. This may involve applications that finalize the object segmentation such as with DL algorithms that use the RoIs as input to neural networks and either confirm that an RoI is an object segment or group the RoIs to form an object segment. Other such applications that either may receive an RoI directly or from a finalizing object segmentation application may perform object recognition, such as those providing semantic labels, and object tracking that tracks the position of the segmented object from frame to frame. Other such applications that may use the RoIs are known and are not limited here. More details of these operations of process 300 are provided below.

Referring to FIG. 4, an event-driven object segmentation system or device 400 has a camera array 402, an event generator 406, and an event-driven object segmentation unit 416 to perform the event-driven operations disclosed herein. The system 400 receives image data of frames from one or more video sequences and provides regions-of-interest (RoIs). The RoIs may be provided to external or internal applications such as an object detection (or object segmentation refinement) unit 424 when needed, as well as an object tracking unit 426 and an object recognition unit 428, forming an event-driven baseline object detector to provide recognized and tracked objects 430 by one example form.

The system 400 exploits the temporal redundancy in security and/or surveillance video frames to identify regions of interest (RoIs) based on motion saliency to detect motion in the images. In such security systems, it is often the case that only the moving objects are of interest. Thus, the present system forces the image analysis to focus on the moving objects.

By one approach, one or more cameras may be used, and here camera array 402 is shown with cameras 404. These may be fixed cameras, as is typical for many security cameras, so that by one form, the present event-driven method does not need to compensate for camera motion. The cameras are pointed toward one or more areas to be monitored to capture motion in those areas whether by people, animals, vehicles, and so forth. Such cameras may be RGB or RGB-D cameras but may be other types of cameras that are monotone or provide grayscale, as long as a difference of intensity or brightness can be provided as the image data. Otherwise, any other image format for which temporal redundancy across frames occurs can be used as the input data type for the event-driven object segmentation pipeline.

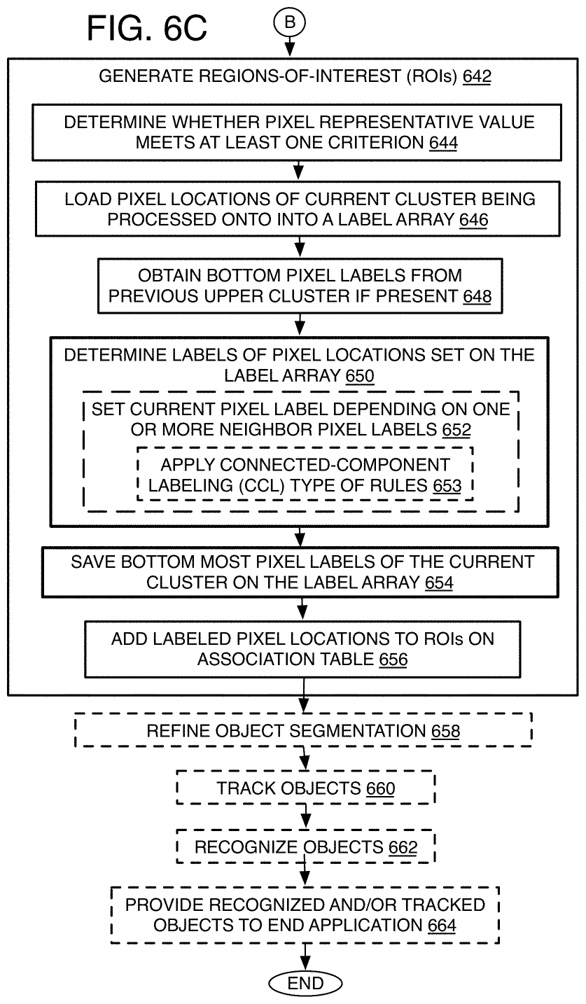

For a given video stream 408, the same line of pixels is fetched for current and previous frames. These pixel rows are then sent to a change detection unit, which also is referred to as an eventifier 410. Eventification is the process of identifying the pixels which have undergone sufficiently significant change in intensity, by example, across two frames, and by one form consecutive frames. By one form, the events 412 are generated by determining both direct (linear) and log differences as described elsewhere herein (see FIG. 7 for example). An image 414 shows a region with the detected events 412 (two people walking) that is to be the focus of the analysis.

By an alternative form, the image signals and events may be generated by a camera with dynamic vision sensor (DVS) that has sensor level circuitry to provide signals that indicate an event as mentioned above. A DVS unit 411 may immediately convert signals to digital pixel-level event indicators to form events 412 that can be used in object segmentation processing. In this case, the eventifier 410 is bypassed or is not provided at all. By one form, when both operations are available, one of the units (eventifier or DVS) may be the back-up operation when the other process is not able to work properly.

The events 412 are then provided to the event-driven object segmentation unit 416, and specifically to a computational content-addressable memory (CCAM) or clustering unit 418 The clustering unit 418 clusters the events based on both spatial and temporal locality. The CCAM lists the clusters as the clusters are first formed by event timestamp for example, and each listing may have anchor coordinates, a cluster size, and the timestamp. Other parameters may be provided as well such as a validity indicator and others that are described below. The output of the CCAM are clusters of events, closely located on the frame, but still considered too disjoint to define object segments in an image.

A cluster grouping unit 420 then determines cluster groups by analyzing the validity of a current cluster and neighbor clusters as classified on the CCAM. The cluster grouping unit 420 then performs a block-sparse convolution only on the CCAM outputs of the valid clusters so as to join them into coherent regions of motion or cluster groups. This is accomplished by performing a single layer convolution that traverses a filter, such as a unity filter, over a cluster group loaded onto a patch array. The filter provides a set of 1s and 0s when centered on a current pixel location, which can then be summed to form a representative value such as a convolutional sum for the current pixel. The result is a convolutional sum for each pixel location on a cluster group where the sum factors adjacent clusters when the current pixel location is close enough to a cluster border so that the filter overlaps two or more adjacent clusters. This operation effectively drops pixels with non-cluster data, which can no longer be tracked, to focus on the salient motion.

Next, a region of interest (RoI) generation unit 422 identifies the individual RoIs and establishes their bounding box coordinates using a labeling technique, such as a connected component labeling (CCL) type of technique described below. The RoI generation unit 422 first compares the per-pixel convolutional sums to a threshold to determine if the pixel location tends to be part of a sufficiently cohesive moving cluster group. The RoI generation unit 422 may have label updating logic that both performs label updating to pixel locations on a label array and updates RoI boundaries on an association table that records and tracks all of the RoIs.

The RoIs from this object segmentation pipeline then may be fed into the object detection unit 424 when needed either to confirm that a RoI is an object segment or to further group RoIs into a single object segment. Such object detection unit may perform DL algorithms and use the RoI as input to a neural network. The RoI or finalized segments then may be provided to an object tracking unit 426 and/or object recognition unit 428 to provide recognized and tracked objects 430, here two people that are walking, shown on image 432.

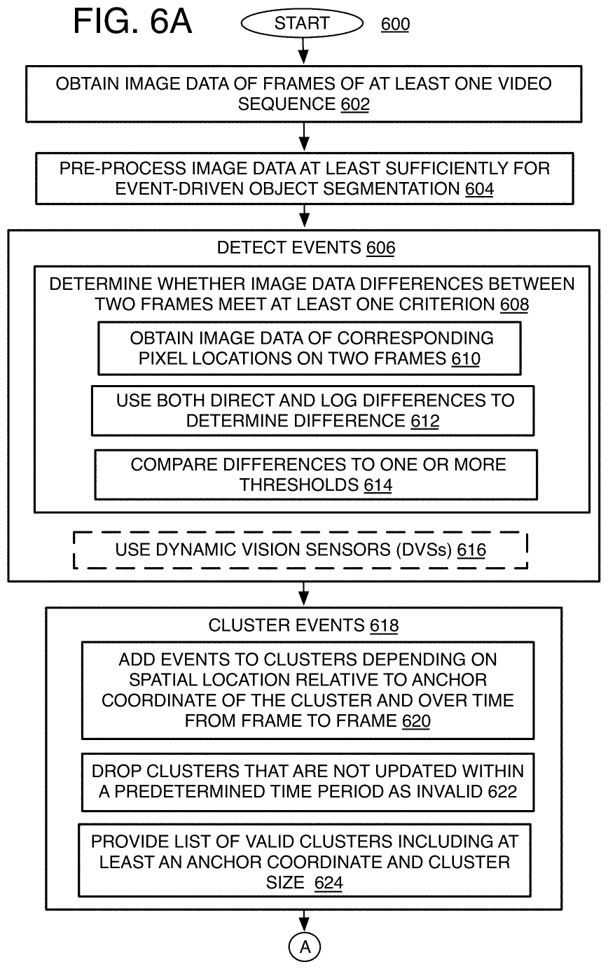

Referring to FIG. 5, another event-driven object segmentation system or device 500, similar to system 400 except showing different details here, has a pipeline for event-driven processing. Here, while multiple video sequences or streams 502 are input for object segmentation, each of the video streams is analyzed separately. For individual frames on the same video stream (here stream 1), image data of the pixel lines of the same corresponding location (or row number) N are compared from a current frame K and previous frame K−1. This may be repeated for all rows of two frames being compared. By one form, the pipeline can context switch across multiple video streams. This may be achieved because the same hardware for event-driven processing can be time-multiplexed across multiple streams, provided the appropriate context is saved for each video stream, such as streams 1-3 shown here. Detecting events is then performed by a log change detection logic, similar to the eventifier 410 mentioned in process 400. The events are then provided to, and stored at, a clustering unit or content addressable memory (CCAM) 508.

The content addressable memory (CCAM) 508 may have control logic to process the motion events and store event information in entries 509 in a cluster list 511 of a memory array of memory cells. Each entry 509 in the memory array stores pixel information, such as an intensity value for a cluster of pixels in an image frame. The entry 509 also may include a first or anchor coordinates x and y, and event parameters such as a polarity change value (pol) which is a plurality of +1 or −1 corresponding to a positive or negative intensity change greater than a given threshold, pixel intensity value (val) which is typically 24-bit RGB or 8-bit grayscale, a timestamp value (Ts), and a cluster size (Tag) which is a width and height (a, b) of the cluster extending from the anchor coordinates that are set at the upper left corner of the cluster. Each dimension may grow separately from the other. The cluster entries 509 in the CCAM 508 may have different combinations of these parameters or may hold other parameters as well such as a valid bit (not shown) in entries 509 that indicates the cluster with at least one event has been updated within a purge time period as mentioned below. The CCAM may comprise binary or ternary (3 parts) content addressable memory, or other suitable content addressable memories, to hold the entries 509.

The size of a cluster grows as events 513 are added to a cluster 510 when an event is within the cluster size (as indicated by the Tag), starting with a distance from the anchor coordinate such as 1 pixel and increasing with each addition of an event that extends the size, as shown visually on a grid 506. Those cluster entries (represented by event 512) without an update or added event within a predetermined purge window or time are evicted or purged from the CCAM 508 as shown on grid 506.

Thereafter, the cluster list 511 is made accessible to, or provided to, a cluster grouping unit 514 that re-orders the cluster list from the CCAM into a reverse mapping table, and then determines cluster validity to form cluster groups 518 shown on pixel grid 516. The cluster grouping unit 514 then uses a filter 520 on a patch array to convolve 522 the cluster groups to form pixel-level convolutional sums as representative values of the cluster group as described herein.

A region-of-interest generator 524 determines which convolutional sums meet at least one criterion, such as a threshold indicating sufficient motion cohesion on the cluster groups and for the individual pixel locations. The region-of-interest generator 524 then labels the thresholded cluster group pixel locations and updates RoI addresses on an association table with added pixel locations depending on the labels as described herein, and to provide the final location of the RoIs 526 such as by upper left and lower right pixel location of each Rot The RoIs then are provided for object detection and/or use as described elsewhere herein as well. By one form, the event-driven object segmentation provided by a RoI generation unit herein only provides RoI bounding box locations on the images without any other segment location definition data, such as exact boundaries of the objects in the RoI.

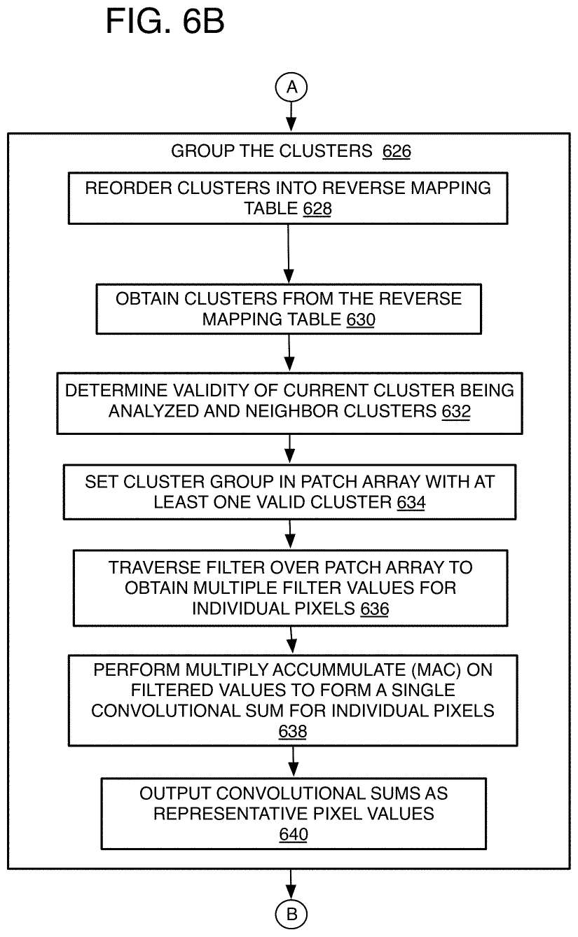

Referring to FIGS. 6A-6C, a process 600 is provided for a method of event-driven object segmentation for imaging processing. In the illustrated implementation, process 600 may include one or more operations, functions or actions 602 to 664 generally numbered evenly. By way of non-limiting example, process 600 may be described herein with reference to example image processing systems or units 400, 500, 1100, or 1200 of FIGS. 4, 5, 11, and 12 respectively, and where relevant.

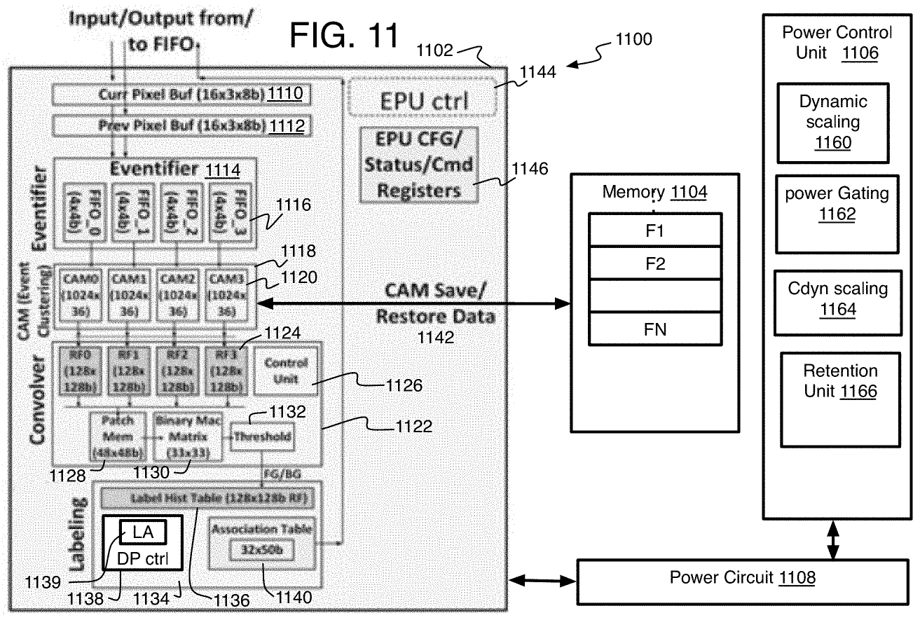

The process 600 may include “obtain image data of frames of at least one video sequence” 602, where multiple video sequences or streams can be handled. The image data may be input to the system with corresponding pixel rows from two frames, and by one form, consecutive frames, but from the same video stream. The video streams are analyzed separately but can be processed in parallel when the hardware, such as the event-drive processing unit 1100 (FIG. 11), has time-multiplexing ability to do so.

The process 600 may include “pre-process image data at least sufficiently for event-driven object segmentation” 604. This may include any pre-processing necessary to provide pixel intensity values (or other image values being used to perform the analysis) such as de-mosaicing, noise reduction, lens shading correction, and so forth. Such pre-processing may be provided for other image quality or performance reasons as well.

The process 600 may include “detect events” 606, and as mentioned may be performed by an eventifier on devices 400 or 500. This operation may include “determine whether image data differences between two frames meet at least one criterion” 608. The criterion determines whether sufficient motion exists that may be a moving object. This may be determined by determining differences in intensity value at a pixel location from frame to frame. Intensities values that do not change significantly still may indicate the same unmoved location on image content but changed slightly by camera tolerances or changes in lighting.

Referring to FIG. 7, the method may determine whether the criterion is met by first including “obtain image data of corresponding pixel locations on two frames” 610, and then “use both direct and log differences to determine difference” 612. An example eventifier logic circuit 700 is provided to eventify the pixels based on linear and log thresholds. The eventifier logic circuit 700 receives two pixel intensities Pₖ and Pₖ₋₁ from current and previous frames of the same video sequence and receives at two leading one detector (LOD) multiplexers 702 and 704 respectively. The LODs compute the log (log₂Pₖ and log₂Pₖ₋₁) of each value. The log values log₂Pₖ and log₂Pₖ₋₁ as well as a logarithmic difference threshold (LGTH) are provided to a difference and comparator multiplexor 706. The multiplexor 706 differences the two log values and compares it to the threshold LGTH. If the difference is larger than or equal to the threshold, then a signal is sent to an AND gate 710. Also, a signal is generated that indicates a polarity sign (whether the intensity rose or fell) that is sent to an OR gate 712, when such polarity is being used for other reasons.

The intensities Pₖ and Pₖ₋₁ also are directly provided to a linear (or direct) difference and comparator multiplexor 708. The multiplexor 708 also differences the two linear values Pₖ and Pₖ₋₁ and compares the difference to a linear difference threshold (LINTH). If the difference is larger than or equal to the threshold, a signal is sent to the ADD gate 710. A direction (rise or fall) of the difference or polarity may be sent to the OR gate 712 which may be used for other reasons.

As shown on the table below, the first column shows an event detected while polarity is positive, the second column shows an event detected when polarity is negative, and the third column shows the results when no event is detected. So for example, when AND gate 710 input signals are present (1) indicating both linear and log events meet their thresholds, then AND gate 710 outputs a one (Abs(comp(j))=1) indicating an event is detected. Also, the sign signals are sent to the OR gate 712 only when an event is indicated. The Sign(comp(j)) shows the digital indicator of the sign/polarity in the third row.

| | | | |
|---|---|---|---|
| Abs(comp(j)) | 1 | 1 | 0 |
| Sign(comp(j)) | 0 | 1 | x |
| Event polarity | + | − | none |

To represent the eventifier circuit 700, the process 600 includes “compare differences to one or more thresholds” 614. When the differences meet the thresholds, an event is established. An event is generated if both the linear (or direct) as well as the log thresholds of the intensity are crossed. Incorporating the log threshold allows the eventifier to handle a wider dynamic range. Both these thresholds are configurable through software and set by experimentation.

As an alternative to the eventifier, the process 600 instead may include “use dynamic vision sensors (DVSs)” 616 which have sensors with circuits to indicate when an event occurs depending on signals from the sensors as described above. The events as indicated by the DVS operations are then provided for clustering of the events.

Process 600 next may include “cluster events” 618. This may include having the process 600 “add events to clusters depending on spatial location relative to an anchor coordinate of the cluster and over time from frame to frame” 620. As mentioned above, rather than storing the segmentation status of each pixel of each frame in a sequence of frames, here the method only stores a first or anchor pixel location of a cluster of events (or event pixels) and then indicates the size of the cluster and the timestamp indicating the last time an event was added to the cluster. This described implementation may use the computational content-addressable memory (CCAM) for sparse representation of the events (each having at least the spatial anchor coordinates and a timestamp) and occurring in a spatiotemporal volume that reduces the storage requirement from O(W*H*d) to O(E), where W and H are spatial dimensions, d represents the depth (or duration) of the time window, and E represents the number of events (or pixels) in the spatiotemporal volume (E<<W*H*d). Incoming events may be added to a cluster when the pixel location of the cluster is within the cluster size or spread indicated by the Tag on the cluster entry (FIG. 5). Thus, for example, if the Tag of a cluster is (1,2), an event within one space horizontally, but within two spaces vertically, from the anchor coordinates of the cluster may be added to the cluster. Once an event is added say 2 spaces away from the anchor coordinate, now the cluster is 3 pixels high in total and the Tag is changed accordingly. Also, when new events are added to a cluster, the cluster's timestamp is updated with that of the added event.

To manage the cluster list on CCAM, process 600 also may include “drop clusters that are not updated within a predetermined time period as invalid” 622. In other words, temporally uncorrelated events are “denoised” by removing events that have not been “reinforced” in a given time window. These clusters are set as invalid and may be purged by being overwritten or may be deleted from the memory array of the CCAM. The combination of clustering and denoising achieves spatial and temporal correspondence of events in the content addressable memory to maintain a required size of the content addressable memory. Another way to state this is that the CCAM stores and clusters a dynamic stream of events. Events with older timestamps can be evicted. In doing so, the CCAM is able to identify any old cluster and filter those. Thus, it achieves in-situ noise filtering.

The spatial window for adding events to a cluster may start at 1 pixel, and the temporal window for setting the purging threshold may be set as a certain number of cycles or frames from the last time a cluster was updated. The spatial and temporal windows may be configurable via software and may be set by experimentation.

The content addressable memory enables compressed storage of sparse spatiotemporal data leading to reduced memory footprint and bandwidth requirements. The inherent ability to compute and store spatial clusters, as well as carry out temporal noise filtering, enables computation near memory without needing any special memory cells.

Process 600 may include “provide list of valid clusters including at least an anchor coordinate and cluster size” 624. Valid here refers to those clusters listed on the CCAM being updated by adding events within a predetermined time period or window measured, by one example, as a certain number of frames or cycles from the last time a cluster was updated. The list can then be used for cluster grouping operations. The validity also may be represented as a validity indicator on the CCAM entries.

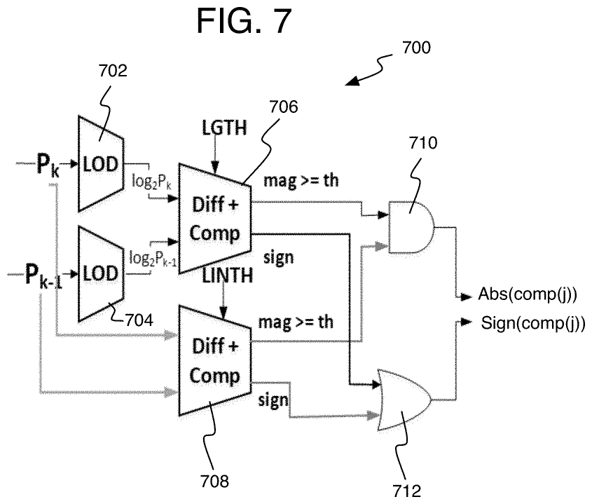

Referring to FIGS. 8 and 8A, a block sparse convolver 800 merges small CCAM clusters 804, 806, 808, 810, and 812 shown on grid 802 into coherent regions of motion referred to herein as a group of clusters (or cluster groups) and discussed with process 600 below. The convolver 800 may have a cluster neighborhood setting unit 814, a cluster validation unit 816, and a convolution unit 818 that has a cluster group loading unit 820 that loads a cluster group 813 onto a patch array 822 that is traversed by a filter 824. A filter values unit 826 that controls the filter and provides resulting filtered values to an accumulation or MAC unit 828, resulting in convolutional sum outputs for individual pixel locations. The operation of the convolver 800 is as follows.

Process 600 may include “group the clusters” 626. This initially may include “reorder clusters into reverse mapping table” 628. Specifically, the CCAM clusters are generally stored in order of timestamp of creation of new clusters as described above. Thus, the CCAM cluster list lists the cluster entries in random order according to the location of the clusters on an image, and specifically the location of the anchor coordinates of the clusters. This becomes more random when old invalid entries are replaced with new entries. Such a random arrangement requires a search of the un-ordered cluster list to find neighbors of a current cluster in order to perform convolution described below. This causes delay and raises computational load unnecessarily.

To resolve this issue, the cluster list at the CCAM is re-ordered into a raster scan order by anchor coordinate of the clusters and placed into fields on the reverse mapping table. When the clusters are in order by anchor coordinates, the neighbor clusters can be easily accessed by accessing the reverse mapping table with the address of the anchor coordinates of each neighbor cluster. Since the block sparse convolution is performed in a raster scan fashion, i.e. in the order of coordinates, this is very efficient. Listing the clusters in this way, allows the block sparse convolver to easily skip over sections of the frame with no valid cluster.

Information regarding each cluster (e.g. size) is stored in the reverse mapping table with the coordinates. Thus, based on the anchor coordinates a given cluster occupies a specific location in the reverse mapping table. By one form, each entry of the reverse mapping table only stores what percentage of a cluster has been actually populated by event clustering. For example, if the cluster can be a maximum of 8×8 pixels, then each entry in the reverse mapping table can specify whether 0×0, 2×2, 4×4 or 8×8, and so forth, of the possible cluster space is occupied during event-clustering.

Process 600 may include “obtain clusters from the reverse mapping table” 630, and as mentioned in raster scan order by this example. This operation also determines which clusters are neighbor clusters to a current cluster being analyzed. The cluster neighborhood setting unit 814 may read the current cluster 804 (FIG. 8) anchor coordinates (i, j) on the reverse mapping table, obtain the current cluster size. The horizontal neighbor clusters 808 and 812 should be the cluster listed just previous and just after the current cluster listing on the reverse mapping table. The vertical neighbor clusters 810 and 806 above and below the current cluster 804 are determined relatively quickly by mapping the clusters in raster-scan order with rows of maximum cluster size blocks so that the clusters with anchor coordinates above and below the current cluster are revealed in an efficient manner. The vertical neighbor clusters 806 and 810 are simply in a cluster row above and below the cluster row of the current cluster with a horizontal overlap of pixel (or maximum cluster block) columns.

Process 600 may include “determine validity of current cluster being analyzed and neighbor clusters” 632, and where the cluster validation unit 816 determines which of the current and neighbor clusters are listed as valid on the CCAM cluster list, or reverse mapping table if listed there, with a valid bit which confirms that at least one event is within the cluster and the cluster has been updated sufficiently recently as explained above. Thus, this operation simply may be a check to see if the valid bit on the CCAM cluster list or reverse mapping table list, is valid. This operation may consume a total amount of time of 9 or 25 cycles per cluster for cluster sizes of 3×3 or 5×5 for example, and depending on how many potential neighbor clusters were found. The system can analyze 1 pixel per cycle. When no valid neighbor clusters are found for a current cluster, the potential cluster group is dropped, and the cluster neighborhood is determined for a next current cluster in raster order. When at least one neighbor cluster is found to be valid, the current cluster is convolved with its neighbor(s) to analyze the clusters as a cluster group on the patch array.

Process 600 may include “set cluster group in patch array with at least one valid cluster” 634. The convolving operations may be performed by a convolution unit 818, and specifically, the cluster group loading unit 820 may set the cluster group in the patch array 822. Here, an entire valid cluster group 813 is placed in the patch array 822 of maximum cluster size blocks 821 so that a convolutional filter traversing the patch will be able to overlap two or more adjacent clusters to give the convolution the full effect of factoring multiple clusters in a cluster group.

The cluster info loaded into the patch array 822 is placed into binary format by using the anchor coordinate and size of the cluster while placing the anchor coordinate at the upper left corner of a block 823 of the maximum cluster size. For example, if the cluster dimensions are 4×4 out of the possible 8×8 size (maximum cluster size), then a 4×4 region is populated with is in the upper left corner of a block of the maximum cluster size and the rest are 0s within that block.

The convolution itself performs the operation:

for m<M and n<N, convolve pixel (m, n) in cluster (i, j)

where (M, N) is the size of the cluster group including all of its pixels (m, n). In other words, each pixel in a cluster along with its neighboring pixels (whatever is covered by an F×F filter 824) is convolved by the filter 824, and that output is a single sum which is assigned to that pixel. The same process is repeated for all pixels in a cluster group. The result is a convolutional sum for each pixel where at least some of the pixels near cluster borders between clusters in the cluster group factor two or more clusters. Thus, the convolutional sum is a per-pixel (or pixel level) representative value of the cluster group from all pixels in the cluster group. By other alternatives, the filter only traverses over all pixels in the center cluster being analyzed, and by one form where each such pixel is in the center of the filter.

In more detail, and to perform the convolution, first, process 600 may include “traverse filter over patch array to obtain multiple filter values for individual pixels” 636, and as performed by the filter values unit 826. The patch array or patch memory array is a 2D array formed for clusters being analyzed together (selected and neighbors) and may be established by a 2D array of hardware such as sequentials (or latches) that may be loaded for convolution.

By one example form, a unity filter 824 is used to join the valid clusters of a cluster group together. The filter is placed over the center of a current pixel being analyzed. Pixels at the edge of the patch or cluster group are not a concern since the convolution is usually being performed for a center cluster around neighbors and that sits in the middle of a patch array (such as a 48×48 pixel patch array). All values of the filter may be 1. Stride may be 1 and the size can span 3×3 pixels or 5×5 pixels by one example, but could be up to a maximum of 32×32 in other examples. Both the filter size and the maximum possible cluster size also may be configurable via software and set by experimentation.

Process 600 may include “perform multiply accumulate (MAC) on filtered values to form a single sum for individual pixels” 638, and by one form, performed by the accumulation unit 828. Here the filter values for each pixel, which for a 3×3 filter being nine ones and zeros, are then summed in an MAC circuit to generate a single convolutional sum. Since the filter is a unity filter with all 1 coefficients, the nine filter values for a pixel are the binary values of pixels on the patch array and no multiplication is needed with the coefficients. In some cases, the max filter size could be as large as 32×32 so that when all is are present around a pixel location with a 1. The maximum sum is 1024.

As to the timing, 1 convolution per cycle can be performed and the number of MAC operations depends on the filter size. The number of cycles that are needed for a convolution of a single cluster may be 16, 64, or 256 depending on whether a cluster size is 4×4, 8×8, or 64×64 for example, but the total number of convolution cycles depends on the number of clusters. The result is that the block sparse convolution implementation has a “latency” that is proportional to the number of clusters detected by the CCAM rather than the resolution of a frame.

Process 600 may include “output convolutional sums as representative pixel values” 640. The output is an 11-bit binary convolved value for each pixel, where the pixel is part of a valid cluster that needs to be convolved. The 11 bit binary value is used to handle up to a maximum value of 1024.

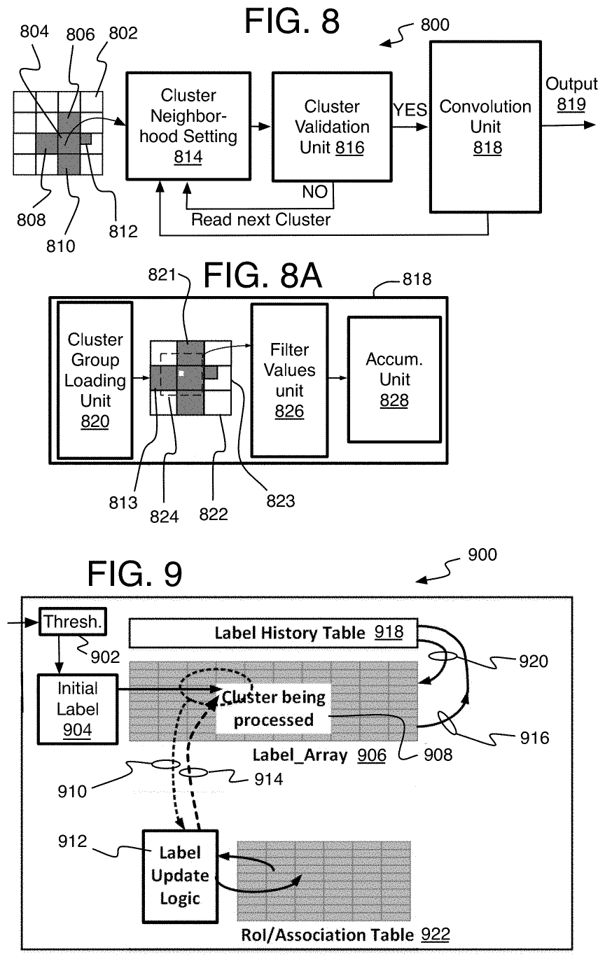

Referring to FIG. 9, process 600 may include “generate regions-of-interest (RoIs)” 642. This involves determining the bounding box (bbox) coordinates for the RoIs. To perform this operation, a region-of-interest (RoI) generation unit 900 has a thresholding unit 902 that determines whether the pixel convolutional sums pass a cohesive motion threshold, an initial label unit 904 that provides an initial label for those pixel locations that pass the threshold, a label array 906 to hold the initial labels as pixels are added and labels are updated, an ROI/Association table 922 that records and maintains the definitions of the RoIs, a label update logic unit 912 that updates labels on the label array 906 and updates the RoIs on the association table 922. A label history table 918 also is provided to store labels of a neighbor cluster when a current cluster is provided on the label array 906. The details of the region-of-interest generation of process 600 as performed by the RoI generation unit 900 are provided below.

Process 600 may include “determine whether pixel representative values meet at least one criterion” 644, and this also may be referred to as the convolutional sums when the convolution cluster grouping technique is being used. Each pixel convolutional sum output or representative value is compared to a threshold by the thresholding unit 902. The threshold may be set be experimentation and is adjustable in software. The greater the convolutional sum, the greater the greater number of events around a pixel, which tends to show that the clusters should be grouped together. Particularly, once pixels of all valid clusters (clusters of which have neighboring clusters containing events and are updated sufficiently recently) are convolved, clusters with correlated events of cohesive moving regions tend to have high convolution values because neighboring clusters also have events, and in contrast to clusters with random events which are spatially apart.

Process 600 then may include “load pixel locations of current cluster being processed onto a label array” 646, and by the initial label unit 904. The initial label unit 904 then labels a pixel location on the label array 906 with a 1 for those pixels that pass the threshold, and by one form, only those pixels with a value greater than the threshold. All other pixel locations are provided a zero on the label array 906. Thus, only the clusters with high values of convolution that tend to stand out and indicate a cohesive moving region are kept as possible RoIs. The result is a binary image on the label array where the 1s are showing areas of motion. It will be understood that the thresholding unit 902 could be part of the convolver 800, or could be separate from both the convolver 800 and RoI generator 900.

The convolution and the labeling or ROI generation units are pixel pipelined. In other words, once the convolutional sum of a single pixel is derived, it is thresholded and passed to the RoI generation unit 900 for labeling. This has the effect of loading one cluster at a time into the label array 906, and this may be performed in raster-scan order of the clusters. Also, the loading of a cluster into the label array 906 may be performed by adding and analyzing one pixel row at a time, and saving or maintaining the labels of the cluster as the rows are added one row at a time to the label array until the entire cluster is on the label array. Thus, the label array is an array that holds the labels of pixels and their neighbors at a given point in time, and may be thought of as a sliding window holding label information. The format of each element or pixel label on the label array may be {<valid bit><5-bit label>} for a maximum label of 11111 (or 0 to 31) for a total of 32 labels possible, and where the valid bit indicates validity as new pixel labels are stored to track the validity of the labels from frame to frame and ensure no erroneous old labels are present. By one example, all of the valid bits of each label field is reset for each frame.

Process 600 may include “obtain bottom pixel labels from previous upper cluster if present” 648, and from the label history table 918. Particularly, the labels on the label array 906 will be updated by using previously updated labels on a pixel above and to the left of a current pixel being analyzed. For a current cluster 908 loaded onto the label array and that has an upper neighbor cluster, the upper neighbor pixel labels are missing for the top-most pixels of the current cluster on the label array 906. Thus, when the system updates the labels of a previous cluster's bottom-most pixels on the label array, those bottom-most labels are stored in the label history table 918 to be used later as upper neighbor pixel labels for a lower later cluster subsequently loaded onto the label array 906. For the present operation 648, the labels from the label history array are being placed 920 onto the label array 906 for use and when those labels are present and needed by a lower cluster. The positioned labels are then placed in the appropriate pixel locations (or treated as if the labels were so placed) in the label array 906 and above the top-most pixel locations on the cluster 908 already in the label array 906 to be used as upper neighbor pixel labels for those top-most pixel locations. The format of the labels in the label history table 918 is the same as that of the label array 906, and by one form, the label history table 918 has a capacity to hold one label for each column in a frame.

Process 600 may include “determine labels of pixel locations set on the label array” 650. This may be performed by the label update logic unit 912 and may include heuristic rules to label a current pixel location. Accordingly, this operation may include “set current pixel label depending on one or more neighbor pixel labels” 652. In this case, a technique is used that determines neighbor labels and modifies a current pixel label depending on those neighbor labels. By one form, only the left pixel neighbor and upper pixel neighbor are used to modify a current pixel label, although other variations could be used.

By one form, this operation may include “apply connected-component labeling (CCL) type of rules” 653. A CCL type of algorithm reviews the pixels in an image on the left of the row of cluster (or cluster group) pixels on the top line, and moves in raster order from left to right and down rows of the cluster. The algorithm starts a new region-of-interest with a new label whenever a pixel does not have upper and left neighbor labels to modify its own label. Other rules for modifying the label that are being used here are listed below. By one form, the initial labels are 1 (00001) and the labels are updated by increasing by 1 for each additional label that is added.

The label update logic 912 works on each pixel and determines the pixel's label based on the label of its neighbors (left and above). Three rules are used here to update labels of a current pixel:
(1) If none of the pixel neighbors have a valid label (i.e. does not belong to any RoI), the pixel is assigned a new label.
(2) If one or more pixel neighbors have a label, the pixel is assigned to the minimum label in that RoI (or in other words, the minimum label between the two neighbors).
(3) If it is the first pixel location of an RoI, it is provided a first unique label as mentioned above by incrementing the label value upwards by 1 for example from the last added label.

To perform this operation, the label update logic looks up the location of the current pixel being analyzed, and determines the locations of the left and upper neighbor pixels. The neighbor labels 910 are read and provided to the label update logic unit 912. The label update logic unit 912 then modifies the label of the current pixel according to rules (1) to (3) above although other rules could be added or used instead. The modified label 914 is then placed onto the label array 906.

Process 600 then may include “save bottom-most pixel labels of the current cluster on the label array” 654, and by one form, the bottom-most pixel labels 916 just updated are saved to the label history table 918. This may be performed for each cluster, or may be performed for only those clusters that are known to be above another cluster on the images. This update may replace the previous data that is in the label history table 918 so that only a single row's worth of data need be stored in the label history table 918 at any one time.

Process 600 may include “add labeled pixel locations to RoIs on association table” 656. The label update logic 912 also passes the label of the current pixel and the coordinates of the current pixel to the association table 922. The label update logic 912 updates the RoI entries on the association table 922 by adding the pixel location to the RoI with the same label (or starting a new RoI when no such label is listed on the association table 922 yet), and then modifying the bounding box coordinates of that RoI to include the newly added pixel location. Here, it is understood that the label acts as an RoI index entry. By one form, the bounding box entries have a format of {<valid><RoI Label><x1>y1><x2><y2>} where (x1, y1) are the coordinates of the upper left corner of the bounding box and (x2, y2) are the coordinates of the lower right corner of the bounding box, although other variations may be used. Each RoI has a separate one of these entries thereby forming the index or list of the RoIs. The valid indicator indicates a valid RoI as with above, and also may be reset after each frame, by some examples

Process 600 may include “refine object segmentation” 658. Thus, when the RoIs cannot be provided directly to an object recognition application, further analysis may be performed by an object detection application that either confirms that an RoI is an object segment or groups RoIs together to form a single object segment. By one form, this may include the use of deep learning including deep neural networks where the RoIs are input to the neural network. Many other variations exist. This may be performed by the object detection unit 424.

Process 600 may include “track objects” 660, where objects may be tracked from frame to a frame in one or more video sequences. This either may use the RoIs directly or the refined object segments.

Process 600 may include “recognize objects” 662, where objects may be recognized semantically, such as people versus vehicles, and so forth. This application also either may use the RoIs directly or the refined object segments.

Process 600 may include “provide recognized/tracked objects to end applications” 664. Where other end programs may receive the recognized or tracked results such as a security program that alerts authorities, and so forth.

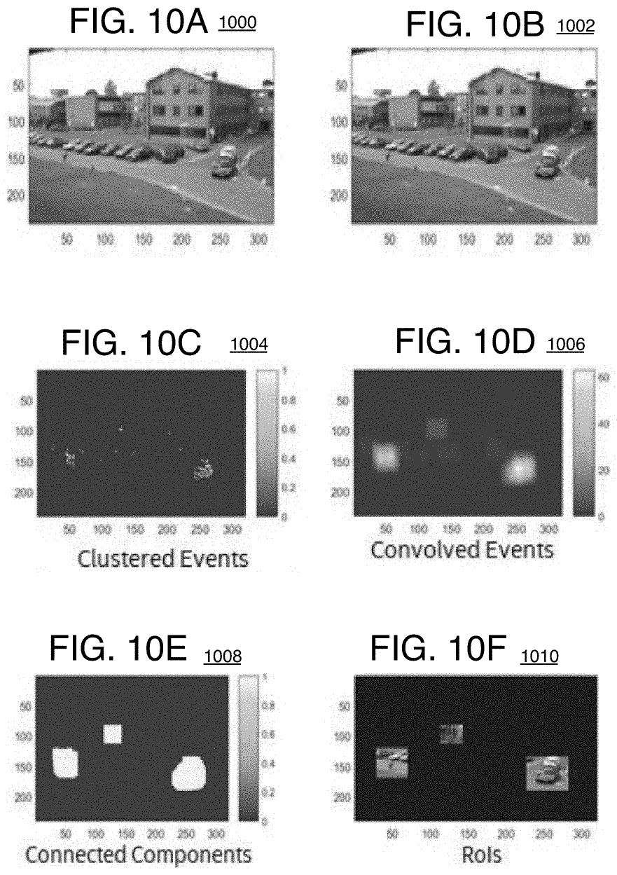

Referring to FIGS. 10A-10F, images or charts that show results of the various stages of process 300 or 600. For example, images 1000 and 1002 respectively are input images from frames k−1 and k. Chart 1004 shows clustered events as obtained from the CCAM, while chart 1006 shows convolved events being the result from convolver 800 for example. The differences in color (or grayscale when viewed in black and white) indicate different clusters or regions after convolution. A chart 1008 shows connected components as the result from the region-of-interest generation, and image 1010 shows the resulting RoIs of moving objects in the image while everything that is stationary is removed or otherwise out of the RoIs is removed.

Referring to FIG. 11, an example event-driven processing unit (EPU) 1100 shows the architecture used to perform some or all of the event-driven operations disclosed herein. Other alternatives for the hardware structure shown here may be used instead.

The EPU 1100 may have a circuit 1102 that has the hardware elements mentioned below, and may be communicatively connected to a backup memory 1104 and a power control unit 1106 via a power circuit 1108, any of which may or may not include hardware on the same board or circuit 1102 as the EPU 1100. The EPU 1100 has an EPU ctrl 1144 to control high level operations including data transmissions on and off the EPU, transmissions between components on the EPU, and turning components on and off for example. An EPU CFG/Status/Cmd Registers 1146 provides initial or default settings, reports status of the different components, and provides command registers for high level operation of the EPU.

As to the event-driven object segmentation, the EPU 1100 has a current pixel buffer 1110 and a previous pixel buffer 1112 that may hold data of pixels from a current and previous frame respectively to be compared to determine whether events exist. The EPU 1100 has a parallel IO bus over which it receives the pixels from the current and the previous frame. These buffers 1110 and 1112 may be 16×3×8 bits each to hold intensity values of the pixels The pixel data to be placed in the buffers as well as RoI data transmitted from the EPU may be transmitted to and from one or more external FIFO buffers and by using the same parallel interface to do so. By one example, the external buffers may be accessible to other applications and processors.

The EPU 1100 also may have an eventifier 1114, a clustering unit 1118, and a convolver 1122, each with multiple pathways forming separate pipelines so that different video sequences, or different parts of the same video sequence, may be processed in parallel. Here, four pathways are established but more or less could be provided instead. The EPU 1100 also has a RoI generator 1134 that can meet the needs of the parallel pathways by time multiplexing the context of each of the video sequences.

The eventifier 1114 has parallel event generating or detecting units (or just event units) 1116, for example, each with an on-board FIFO buffer 0 to 3, and each with eventifier logic as with logic circuit 700 (FIG. 7). The circuit may be implemented by flip-flops.

The clustering unit 1118 has four parallel CCAMs 0 to 3 1120. The CCAMs are described above to form clusters and each have a capacity of 1024×36 bits to each list 1024 clusters where each entry has a 36 bit capacity (e′ in FIG. 5) for example.

The convolver 1122 has four parallel register files (RFs) 1124 to receive data of clusters and store the clusters in raster scan order for retrieval for convolution. The capacity of these RF units 1124 is 128×128 bits by one example. By one example, the RF components here are formed of 8-T 1R1W hard macro RFs.

A control unit 1126 manages the placement of data in the convolver components and the operation of the components, while a patch memory array 1128 receives the cluster groups for convolution. The patch array 1128 may have a capacity of 48×48 bits by one example. The control unit 1126 performs the validation and convolution tasks mentioned including the traversing of the filter at the patch array. A binary MAC matrix unit 1130 with a 33×33 bit capacity is used to accumulate filter values into the convolutional sums. A threshold unit 1132 compares thresholds to the convolutional sums.

As mentioned, the RoI generator 1134 also is placed on the EPU 1100. Otherwise, the EPU may transmit cluster groups and other pixel data external to the EPU and to other processors to perform the RoI generation. This transmission, however, would entail almost 1 MB of data, which would significantly increase storage and latency requirements, and external processors cannot usually handle such pixel-level information efficiently so that it is not practical.

Nor is it beneficial to have the EPU 1100 perform the labeling while having the RoI bounding boxes formed externally of the EPU 1100 to divide the RoI generator tasks. Specifically, a single-pass CCL algorithm requires very large memory and hence is not amenable to hardware implementation. Thus, a two-pass CCL algorithm is used. While the EPU 1100 implements the first-pass of the 2-pass algorithm where it determines unique RoIs and their association thereby determining updated labels, the 2nd pass (implemented in either hardware or software) could be implemented outside of the EPU 1100 to determine the final bounding box coordinates by filtering the associated RoIs. However, typically connected-component labeling is used to label each pixel in the foreground to distinguish RoIs from one another so therefore, the EPU is defining ROIs anyway. Thus, passing out the label information for each pixel from the EPU will result in expensive data movement and a follow-on requirement to determine the bbox requirement for each RoI again based on the label information from the EPU to form the final bounding boxes externally of the EPU.

To alleviate this problem, the RoI generator 1134 on the EPU 1100 has an association table 1140 that maintains a running record of the bounding box coordinates for each new RoI introduced and updates the bounding box coordinates of any RoI encountered before. The association table 1140 contains the bounding box coordinates for the final RoIs. Thus, the RoI generator 1134 both labels the pixels on a label array 1139, which may be part of a datapath ctrl (DP ctrl) 1138 or communicating therewith, and sets the RoI bounding boxes at the association table 1140. The label update logic also is provided by the datapath ctrl 1138. The association table 1140 may have a capacity of 32×50 bits. The components of the RoI generator 1134 may be implemented by genram flow using stdcell latches for compact layout. A label history table 1136 may be implemented by a 128×128 register file (RF).

The EPU 1100 also may be connected to the backup memory 1104. The memory 1104 may be used for context switching to time multiplex any of the shared components on the EPU 1100 such as the components of the RoI generator 1134. The memory may be used to store CCAM data and so forth. Field F1 to FN may be provided for storing clusters for example.

Also, the EPU 1100 may be communicatively connected to a power circuit 1108 that is controlled at least partially by a power control unit 1106. The power management for the EPU has been configured such that the EPU power scales with the number of events. The following are further power management schemes that may be used.

A dynamic scaling unit 1160 controls the power circuit 1108 to provide dynamic voltage and frequency scaling across multiple video streams when present. The voltage and frequency of the EPU 1100 can be scaled proportional to the number of events. This allows the performance for the EPU 1100 to be increased by increasing voltage and/or frequency for one or more video streams producing a large number of events. Similarly, the voltage and/or frequency can be reduced when little change occurs across frames of a video sequence, thus improving energy-efficiency. This can be achieved by using a low dropout (LDO) voltage regulator.

A power gating unit 1162 provides power gating between frames from the same or different video streams. Specifically, for real-time workloads, time exists between two consecutive frames when the EPU 1100 is idle. The EPU 1100 can be power gated during that time to save leakage power. By one example, leakage power can be reduced by about 10 when using the power gating. This can be achieved by using power gates arranged to gate the voltage supply going to the EPU 1100.

A Cdyn scaling unit 1164 provides Cdyn scaling both intra (within a single stream) as well as inter-streams. CCAM Cdyn can be dynamically scaled based on the number of clusters in the CCAM. A small number of events typically results in a small number of clusters in the CCAM. If the CCAM has a capacity for 1024 entries and only 100 valid entries are present in the CCAM, only 256 match lines can be enabled in the CCAM, where a match line is a match between an event and a cluster entry. The remaining match lines can be disabled, thus reducing Cdyn during operation. When the number of valid entries increases beyond (256-Threshold), the match lines can be added again. This could be applied to multiple streams so that streams with a large number of match lines has increased Cdyn while the streams with few match lines have the Cdyn reduced. Such operation whether for a single stream or multiple streams significantly reduces power consumption also based on the number of events.

A retention unit 1166 provides for intra-stream retention. When the EPU 1100 enters into a low-leakage retention state during the process of eventification and event-clustering, and if no event is generated for a period of time that is greater than some threshold, then only the eventifier logic 1114 may be functional and continuously monitoring for events. The rest of the logic (CCAM 1118, convolver 1122, and RoI generator 1134) may remain in a low-leakage retention state. This low-leakage retention state retains the state of these units while voltage on these units are lowered and the clock is gated. This low-leakage retention is expected to reduce the leakage by about half. This also is achieved by using power gates. During retention, primary power gates that are used for power gating are turned OFF and the retention power gates are turned ON. Since the clock to EPU is gated during retention, only leakage current flows through these retention power gates, thereby dropping the voltage on an EPU rail from a main rail. Essentially these retention power gates act as a voltage clamp.

The efficacy of the event-driven processing approach has been benchmarked with several real-world video sequences with YOLOv2 serving as the deep learning based object detector for both the conventional system and event-driven system. For the workloads considered, the event-driven approach achieved a 45% average savings in memory BW and compute compared to a system that performed YOLOv3.

In addition, any one or more of the operations of FIGS. 3 and 6A-6C may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more computer or machine-readable media. In general, a machine-readable medium may convey software in the form of program code and/or instructions or instruction sets that may cause any of the devices and/or systems to perform as described herein. The machine or computer readable media may be a non-transitory article or medium, such as a non-transitory computer readable medium, and may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or fixed function firmware that stores instructions executed by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or fixed function firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

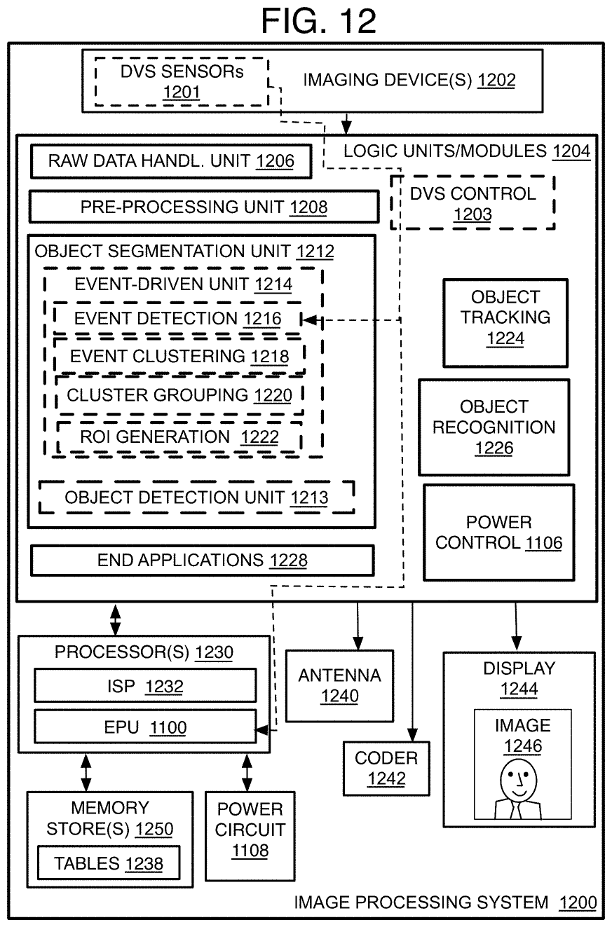

Referring to FIG. 12, an example image processing system 1200 is arranged in accordance with at least some implementations of the present disclosure. In various implementations, the example image processing system 1200 may have an imaging device 1202 to form or receive captured image data. This can be implemented in various ways. Thus, in one form, the image processing system 1200 may be one or more digital video cameras or other image capture devices, and imaging device 1202, in this case, may be the camera hardware and camera sensor software, module, or component. In other examples, image processing system 1200 may have one or more imaging devices 1202 that includes or may be one or more cameras, and logic modules 1204 may communicate remotely with, or otherwise may be communicatively coupled to, the imaging device 1202 for further processing of the image data.

Thus, image processing system 1200 may be a single camera alone or on a multi-camera device or camera network such as a camera array. This may include camera security or surveillance networks, but also may include other fixed cameras such as webcams, and so forth. Mobile cameras when in fixed position could be used as well such as a smartphone, tablet, laptop, or other mobile device, and including computer vision cameras and sensors on robots, VR, AR, or MR headsets, and so forth. Otherwise, device 1200 may be the device with one or more cameras where the processing occurs at one of the cameras or at a separate processing location communicating with the cameras whether on-board or off of the device, and whether the processing is performed at a mobile device or not.

In any of these cases, such technology may include a camera or camera array such as a digital camera system, a dedicated camera device, or other video camera, or some combination of these. Thus, in one form, imaging device 1202 may include camera hardware and optics including one or more sensors as well as auto-focus, zoom, aperture, ND-filter, auto-exposure, lights, and actuator controls. The imaging device 1202 also may have a lens, an image sensor with a RGB Bayer color filter, an analog amplifier, an A/D converter, other components to convert incident light into a digital signal, the like, and/or combinations thereof. The digital signal also may be referred to as the raw image data herein.

Other forms include a camera sensor-type imaging device or the like (for example, a webcam or webcam sensor or other complementary metal-oxide-semiconductor-type image sensor (CMOS)) in addition to, or instead of, the use of a red-green-blue (RGB) depth camera and/or microphone-array to locate who is speaking. The camera sensor also may support other types of electronic shutters, such as global shutter in addition to, or instead of, rolling shutter, and many other shutter types. In other examples, an RGB-Depth camera and/or microphone-array might be used in the alternative to a camera sensor. In these examples, in addition to a camera sensor, the same sensor or a separate sensor may be provided as well as light projector, such as an IR projector to provide a separate depth image that can be used for triangulation with the camera image.

The imaging device 1202 also may optionally have DVS sensors 1201 to receive signals that indicate events in situ. This includes sensor level circuits that obtain these signals.

In the illustrated example and relevant here, the image processing system 1200 also may have one or more processors 1230 which may include the EPU 1100 and as described above to perform the event-driven object segmentation operations. One or more dedicated image signal processors (ISPs) 1232 such as the Intel Atom also may be provided as well as other GPUs and/or dedicated specific-purpose hardware to run any of the object segmentation or other operations mentioned herein.

The logic modules 1204 may include a raw image handling unit 1206 that performs pre-processing such as demosaicing on the image data and then a pre-processing unit 1208 that performs further sufficient pre-processing tasks as mentioned above at least for object segmentation. The logic modules 1204 also may have an object segmentation unit 1212. By one alternative example, the object segmentation unit 1212 may have an event-driven unit 1214 to perform some or all of the event-driven object segmentation in software and other processors, such as a CPU or ISP, that is not on the EPU 1100. In this alternative, the event-driven unit 1214 may have an event detection unit 1216, event clustering unit 1218, cluster grouping unit 1220, and/or a RoI generation unit 1222. This may be provided in addition to the EPU 1100 as a back-up system or as the primary system when using the EPU 1100 as the backup system. Otherwise, the object segmentation unit 1212 unit may have an object detection unit 1213 to finalize object segments based on the RoIs as described above and when desired.

The logic modules 1204 also may optionally include a DVS Control 1203 that converts the event signals from the DVS sensor and sensor circuits 1201 into event indicators and that can be used for clustering instead of events generated by the event detection unit 1216. Such DVS events still may be managed by the event detection unit 1216 or may be provided directly to the even clustering unit 1218. Otherwise, the logic modules 1204 may include an object tracking unit 1224, object recognition unit 1226, and/or other end applications 1228 that use or further refine object segments.

A power control unit 1106 may be provided by the logic module 1204 and that performs the power savings techniques described above and may control a power circuit 1108 that controls the power to the processor(s) 1230.

The image processing system 1200 also may have the memory store(s) 1250 to store the backup data mentioned above for memory 1104 (FIG. 11) and/or any of the lists or tables 1238 mentioned above when desired to be external from the EPU 1100. One or more displays 1244 may provide images 1246, and a coder 1242 may be provided to decode and/or encode image data. An antenna 1240 may be provided for sending or receiving image data transmissions. In one example implementation, the image processing system 1200 may have the at least one processor 1230 communicatively coupled to the logic modules 1204, display 1244, and at least one memory 1224.

As illustrated, any of these components may be capable of communication with one another and/or communication with portions of logic modules 1204 and/or imaging device 1202. Thus, processors 1230 may be communicatively coupled to both the image device 1202 and the logic modules 1204 for operating those components. By one approach, although image processing system 1200, as shown in FIG. 12, may include one particular set of blocks or actions associated with particular components or modules, these blocks or actions may be associated with different components or modules than the particular component or module illustrated here.

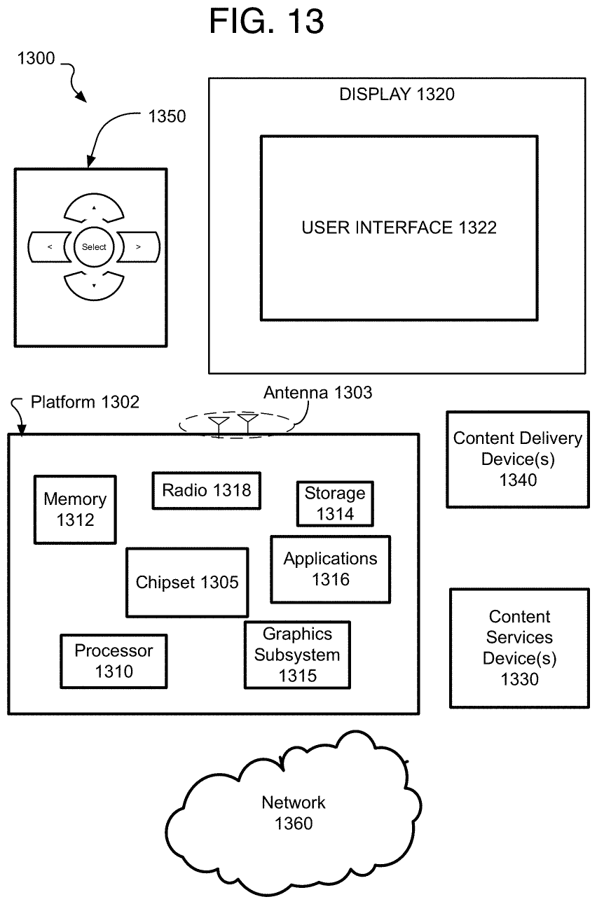

Referring to FIG. 13, an example system 1300 in accordance with the present disclosure operates one or more aspects of the image processing systems described herein. It will be understood from the nature of the system components described below that such components may be associated with, or used to operate, certain part or parts of the image processing system 1300 described above, and therefore, used to operate the methods described herein. In various implementations, system 1300 may be a media system although system 1300 is not limited to this context. For example, system 1300 may be incorporated into a digital video camera, a fixed camera array and network, a mobile device with camera or video functions such as an imaging phone, webcam, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 1300 includes a platform 1302 coupled to a display 1320. Platform 1302 may receive content from a content device such as content services device(s) 1330 or content delivery device(s) 1340 or other similar content sources. A navigation controller 1350 including one or more navigation features may be used to interact with, for example, platform 1302 and/or display 1320. Each of these components is described in greater detail below.

In various implementations, platform 1302 may include any combination of a chipset 1305, processor 1310, memory 1312, storage 1314, graphics subsystem 1315, applications 1316 and/or radio 1318. Chipset 1305 may provide intercommunication among processor 1310, memory 1312, storage 1314, graphics subsystem 1315, applications 1316 and/or radio 1318. For example, chipset 1305 may include a storage adapter (not depicted) capable of providing intercommunication with storage 1314.

Processor 1310 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1310 may be dual-core processor(s), dual-core mobile processor(s), and so forth. By one form, processor 1310 is implemented as EPU 1100 with or without additional processors.

Memory 1312 may be implemented as a volatile memory device such as, but not limited to, a Random Access Memory (RAM), Dynamic Random Access Memory (DRAM), or Static RAM (SRAM).

Storage 1314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1314 may include technology to increase the storage performance enhanced protection for valuable digital media when multiple hard drives are included, for example.

Graphics subsystem 1315 may perform processing of images such as still or video for display. Graphics subsystem 1315 may be a graphics processing unit (GPU) or a visual processing unit (VPU), for example. An analog or digital interface may be used to communicatively couple graphics subsystem 1315 and display 1320. For example, the interface may be any of a High-Definition Multimedia Interface, Display Port, wireless HDMI, and/or wireless HD compliant techniques. Graphics subsystem 1315 may be integrated into processor 1310 or chipset 1305. In some implementations, graphics subsystem 1315 may be a stand-alone card communicatively coupled to chipset 1305. The graphics subsystem 1315 may be or include the EPU 1100, or may communicate with the EPU 1100, to provide one, some, or all of the object segmentation processing operations of EPU 1100 mentioned above.

The graphics and/or video processing techniques described herein may be implemented in various hardware architectures including the EPU 1100. For example, graphics and/or video functionality may be integrated within a chipset. Alternatively, a discrete graphics and/or video processor may be used. As still another implementation, the graphics and/or video functions may be provided by a general purpose processor, including a multi-core processor. In further implementations, the functions may be implemented in a consumer electronics device.

Radio 1318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1318 may operate in accordance with one or more applicable standards in any version.

In various implementations, display 1320 may include any television type monitor or display. Display 1320 may include, for example, a computer display screen, touch screen display, video monitor, television-like device, and/or a television. Display 1320 may be digital and/or analog. In various implementations, display 1320 may be a holographic display. Also, display 1320 may be a transparent surface that may receive a visual projection. Such projections may convey various forms of information, images, and/or objects. For example, such projections may be a visual overlay for a mobile augmented reality (MAR) application. Under the control of one or more software applications 1316, platform 1302 may display user interface 1322 on display 1320.

In various implementations, content services device(s) 1330 may be hosted by any national, international and/or independent service and thus accessible to platform 1302 via the Internet, for example. Content services device(s) 1330 may be coupled to platform 1302 and/or to display 1320. Platform 1302 and/or content services device(s) 1330 may be coupled to a network 1360 to communicate (e.g., send and/or receive) media information to and from network 1360. Content delivery device(s) 1340 also may be coupled to platform 1302 and/or to display 1320.

In various implementations, content services device(s) 1330 may include a cable television box, personal computer, network, telephone, Internet enabled devices or appliance capable of delivering digital information and/or content, and any other similar device capable of unidirectionally or bidirectionally communicating content between content providers and platform 1302 and/display 1320, via network 1360 or directly. It will be appreciated that the content may be communicated unidirectionally and/or bidirectionally to and from any one of the components in system 1300 and a content provider via network 1360. Examples of content may include any media information including, for example, video, music, medical and gaming information, and so forth.

Content services device(s) 1330 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1302 may receive control signals from navigation controller 1350 having one or more navigation features. The navigation features of controller 1350 may be used to interact with user interface 1322, for example. In implementations, navigation controller 1350 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1350 may be replicated on a display (e.g., display 1320) by movements of a pointer, cursor, focus ring, or other visual indicators displayed on the display. For example, under the control of software applications 1316, the navigation features located on navigation controller 1350 may be mapped to virtual navigation features displayed on user interface 1322, for example. In implementations, controller 1350 may not be a separate component but may be integrated into platform 1302 and/or display 1320. The present disclosure, however, is not limited to the elements or in the context shown or described herein.

In various implementations, drivers (not shown) may include technology to enable users to instantly turn on and off platform 1302 like a television with the touch of a button after initial boot-up, when enabled, for example. Program logic may allow platform 1302 to stream content to media adaptors or other content services device(s) 1330 or content delivery device(s) 1340 even when the platform is turned “off.” In addition, chipset 1305 may include hardware and/or software support for 8.1 surround sound audio and/or high definition (7.1) surround sound audio, for example. Drivers may include a graphics driver for integrated graphics platforms. In implementations, the graphics driver may comprise a peripheral component interconnect (PCI) Express graphics card.

In various implementations, any one or more of the components shown in system 1300 may be integrated. For example, platform 1302 and content services device(s) 1330 may be integrated, or platform 1302 and content delivery device(s) 1340 may be integrated, or platform 1302, content services device(s) 1330, and content delivery device(s) 1340 may be integrated, for example. In various implementations, platform 1302 and display 1320 may be an integrated unit. Display 1320 and content service device(s) 1330 may be integrated, or display 1320 and content delivery device(s) 1340 may be integrated, for example. These examples are not meant to limit the present disclosure.

In various implementations, system 1300 may be implemented as a wireless system, a wired system, or a combination of both. When implemented as a wireless system, system 1300 may include components and interfaces suitable for communicating over a wireless shared media, such as one or more antennas 1303, transmitters, receivers, transceivers, amplifiers, filters, control logic, and so forth. An example of wireless shared media may include portions of a wireless spectrum, such as the radio frequency (RF) spectrum and so forth. When implemented as a wired system, system 1300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, text (“texting”) message, social media formats, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 13.

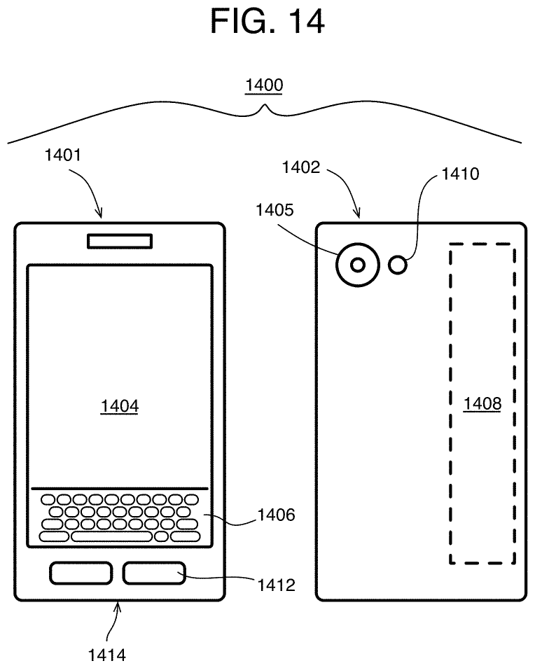

Referring to FIG. 14, a small form factor device 1400 is one example of the varying physical styles or form factors in which systems 1200 or 1300 may be embodied. By this approach, device 1400 may be implemented as a mobile computing device having wireless capabilities. A mobile computing device may refer to any device having a processing system and a mobile power source or supply, such as one or more batteries, for example.

As described above, examples of a mobile computing device may include a digital video camera, mobile devices with camera or video functions such as imaging phones, webcam, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth. One or more of such mobile devices held in a fixed position may perform the event-driven object segmentation described herein.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 14, device 1400 may include a housing with a front 1401 and a back 1402. Device 1400 includes a display 1404, an input/output (I/O) device 1406, and an integrated antenna 1408. Device 1400 also may include navigation features 1412. I/O device 1406 may include any suitable I/O device for entering information into a mobile computing device. Examples for I/O device 1406 may include an alphanumeric keyboard, a numeric keypad, a touch pad, input keys, buttons, switches, microphones, speakers, voice recognition device and software, and so forth. Information also may be entered into device 1400 by way of microphone 1414, or may be digitized by a voice recognition device. As shown, device 1400 may include a camera 1405 (e.g., including at least one lens, aperture, and imaging sensor) and an illuminator 1410, such as a flash, integrated into back 1402 (or elsewhere) of device 1400. The implementations are not limited in this context.

Various forms of the devices and processes described herein may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further implementations.

By one or more example first implementations, a computer-implemented method of event-driven object segmentation for image processing, comprises obtaining clusters of events indicating motion of image content between frames of at least one video sequence and at individual pixel locations; forming cluster groups depending, at least in part, on the position of the clusters relative to each other on a grid of pixel locations forming the frames and without tracking all pixel locations forming the frames; generating regions-of-interest comprising using the cluster groups; and providing the regions-of-interest to applications associated with object segmentation.

By one or more second implementations, and further to the first implementation, wherein each event indicates a change in image data at a pixel location that meets a criterion deemed to indicate sufficient motion of image content.

By one or more third implementations, and further to the first or second implementation, wherein the clusters are formed by listing an anchor pixel location, a timestamp, and a size of the cluster without listing all pixel locations on an image and without listing all pixels in the cluster.

By one or more fourth implementations, and further to any of the first to third implementations, wherein forming cluster groups comprises listing clusters in an order of anchor coordinates of the clusters on a reverse mapping table.

By one or more fifth implementations, and further to the fourth implementation, wherein the reverse mapping table lists an anchor location and a size of the cluster without listing any more parameters of the cluster.

By one or more sixth implementations, and further to any of the first to fifth implementations, wherein forming cluster groups comprises determining whether neighbor clusters adjacent to a current cluster meet a criterion.

By one or more seventh implementations, and further to any of the first to sixth implementations, the method also comprising placing a cluster group on a patch array, and generating representative pixel values that indicate the number of events near a current pixel.

By one or more eighth implementations, and further to the seventh implementation, wherein at least some of the representative pixel values factor two or more adjacent clusters in the cluster group.

By one or more ninth implementations, and further to the seventh or eighth implementation, wherein forming cluster groups comprises using a single layer convolution to generate the representative pixel values.

By one or more tenth implementations, and further to any of the ninth implementation, wherein no other neural network layers are used.

By one or more eleventh implementations, and further to any of the seventh to tenth implementation, the method also comprising traversing a filter over the patch array to generate the representative pixel values.

By one or more twelfth implementations, and further to the eleventh implementation, the method also comprising determining the representative pixel value as a convolutional sum determined by using the filter; and providing a convolutional sum for individual pixel locations on the cluster group.

By one or more thirteenth implementations, and further to the eleventh or twelfth implementation, wherein the filter is a unity filter.

By one or more fourteenth implementations, and further to any of the eleventh to thirteenth implementation, the method also comprising inputting values from the filter into a multiply-accumulate (MAC) array to generate the representative pixel value.

By one or more fifteenth implementations, and further to the seventh to fourteenth implementation, the method also comprising comparing the representative pixel values to at least one criterion to determine whether a sufficient number of events occur near a pixel to consider the pixel to indicate sufficient cohesive motion among the pixels; and generating the regions-of interest by using only those pixels that meet the at least one criterion.

By one or more sixteenth implementations, and further to the seventh to fifteenth implementation, the method also comprising using fixed function hardware of an event-driven processing unit that forms the clusters, forms the cluster groups, and generates the regions-of-interest, wherein the computational load and processing time depends on the number of clusters that are determined.

By one or more seventeenth implementations, a system of event-driven object segmentation for image processing, comprises a memory storing image data of frames of a video sequence; and at least one event-driven processor being communicatively connected to the memory and being arranged to operate by: obtaining clusters of events indicating motion of image content between frames of a video sequence and at individual pixel locations; forming cluster groups depending, at least in part, on the position of the clusters relative to each other on a grid of pixel locations; generating regions-of-interest comprising using the cluster groups and without tracking all pixel locations forming the frames; and providing the regions-of-interest to applications that use segmented objects.

By one or more eighteenth implementations, and further to the seventeenth implementation, wherein using the cluster groups comprises comparing representative pixel values to at least one criterion to determine whether a sufficient amount of events occur near a pixel to consider the pixel to indicate sufficient cohesive motion among the pixels; and generating the regions-of interest by using only those pixels that meet the at least one criterion.

By one or more nineteenth implementations, and further to the eighteenth implementation, wherein the representative pixel value is a convolutional sum, wherein at least some of the convolutional sums factor multiple clusters in a group of clusters.

By one or more twentieth implementations, and further to any of the seventeenth to eighteenth implementation, wherein generating regions-of-interest comprises setting pixel locations on a label array with an initial label and only with pixel locations that are both in a cluster and have a representative value that passes at least one criterion; and updating the initial label of a pixel location depending on labels of neighbor pixels.

By one or more twenty-first implementations, and further to the twentieth implementation, wherein labels on the label array are formed for one cluster at a time; and wherein generating regions-of-interest comprises storing a bottom-most label of an upper cluster to provide neighbor labels to top-most pixel locations on a lower cluster.

By one or more twenty-second implementations, and further to any of the seventeenth to twenty-first implementation, the system also comprising an association table on the at least one event-driven processor, and wherein generating regions-of-interest comprises updating region-of-interest boundaries on the association table as pixel locations receive updated labels.

By one or more twenty-third implementations, and further to any of the seventeenth to twenty-second implementation, the system also comprising fixed function hardware of the event-driven processing unit arranged to form the clusters, form the cluster groups, and generate the regions-of-interest, wherein the computational load and processing time depend, at least in part, on the number of clusters that are determined.

By one or more twenty-eighth implementations, and further to any of the seventeenth to twenty-first implementation, the system also comprising a power circuit and a power control unit arranged to provide at least one of: dynamic voltage and frequency scaling depending on the number of events, power gating the at least one event-driven processor when the event-driven processor is idle, Cdyn scaling depending on the number of clusters, and retention of states that provide events, clusters, cluster groups, regions-of-interest, or any combination of these at the at least one event-driven processor when no event is generated during a predetermined amount of time.

By one or more twenty-fifth implementations, at least one non-transitory computer-readable article has instructions thereon that cause at least one event-driven computing device to operate by: obtaining clusters of events indicating motion of image content between frames of a video sequence and at individual pixel locations; forming cluster groups depending, at least in part, on the position of the clusters relative to each other on a grid of pixel locations forming the frames and without tracking all pixel locations forming the frames; generating regions-of-interest comprising using the cluster groups and without tracking all pixel locations forming the frames; and providing the regions-of-interest to applications that use segmented objects.

By one or more twenty-sixth implementations, at least one machine readable medium may include a plurality of instructions that in response to being executed on a computing device, causes the computing device to perform the method according to any one of the above examples.

By one or more twenty-seventh implementations, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of event-driven object segmentation for image processing, comprising:
obtaining clusters of events indicating motion of image content between frames of at least one video sequence and at individual pixel locations;
forming cluster groups depending, at least in part, on the position of the clusters relative to each other on a grid of pixel locations forming the frames and without tracking all pixel locations forming the frames;
generating regions-of-interest comprising using the cluster groups; and
providing the regions-of-interest to applications associated with object segmentation.

2. The method of claim 1 wherein each event indicates a change in image data at a pixel location that meets a criterion deemed to indicate sufficient motion of image content.

3. The method of claim 1 wherein the clusters are formed by listing an anchor pixel location, a timestamp, and a size of the cluster without listing all pixel locations on an image and without listing all pixels in the cluster.

4. The method of claim 1 wherein forming cluster groups comprises listing clusters in an order of anchor coordinates of the clusters on a reverse mapping table.

5. The method of claim 4 wherein the reverse mapping table lists an anchor location and a size of the cluster without listing any more parameters of the cluster.

6. The method of claim 1 wherein forming cluster groups comprises determining whether neighbor clusters adjacent to a current cluster meet a criterion.

7. The method of claim 1 comprising placing a cluster group on a patch array, and generating representative pixel values that indicate the number of events near a current pixel.

8. The method of claim 7 wherein at least some of the representative pixel values factor two or more adjacent clusters in the cluster group.

9. The method of claim 7 wherein forming cluster groups comprises using a single layer convolution to generate the representative pixel values.

10. The method of claim 9 wherein no other neural network layers are used.

11. The method of claim 7 comprising traversing a filter over the patch array to generate the representative pixel values.

12. The method of claim 11 comprising determining the representative pixel value as a convolutional sum determined by using the filter; and providing a convolutional sum for individual pixel locations on the cluster group.

13. The method of claim 11 wherein the filter is a unity filter.

14. The method of claim 11 comprising inputting values from the filter into a multiply-accumulate (MAC) array to generate the representative pixel value.

15. The method of claim 7 comprising comparing the representative pixel values to at least one criterion to determine whether a sufficient number of events occur near a pixel to consider the pixel to indicate sufficient cohesive motion among the pixels; and generating the regions-of interest by using only those pixels that meet the at least one criterion.

16. The method of claim 1 comprising using fixed function hardware of an event-driven processing unit that forms the clusters, forms the cluster groups, and generates the regions-of-interest, wherein the computational load and processing time depends on the number of clusters that are determined.

17. A system of event-driven object segmentation for image processing, comprising:
a memory storing image data of frames of a video sequence; and
at least one event-driven processor being communicatively connected to the memory and being arranged to operate by:
obtaining clusters of events indicating motion of image content between frames of a video sequence and at individual pixel locations;
forming cluster groups depending, at least in part, on the position of the clusters relative to each other on a grid of pixel locations;
generating regions-of-interest comprising using the cluster groups and without tracking all pixel locations forming the frames; and
providing the regions-of-interest to applications that use segmented objects.

18. The system of clam 17, wherein using the cluster groups comprises comparing representative pixel values to at least one criterion to determine whether a sufficient amount of events occur near a pixel to consider the pixel to indicate sufficient cohesive motion among the pixels; and generating the regions-of interest by using only those pixels that meet the at least one criterion.

19. The system of claim 18 wherein the representative pixel value is a convolutional sum, wherein at least some of the convolutional sums factor multiple clusters in a group of clusters.

20. The system of claim 17 wherein generating regions-of-interest comprises setting pixel locations on a label array with an initial label and only with pixel locations that are both in a cluster and have a representative value that passes at least one criterion; and updating the initial label of a pixel location depending on labels of neighbor pixels.

21. The system of claim 20 wherein labels on the label array are formed for one cluster at a time; and wherein generating regions-of-interest comprises storing a bottom-most label of an upper cluster to provide neighbor labels to top-most pixel locations on a lower cluster.

22. The system of claim 17 comprising an association table on the at least one event-driven processor, and wherein generating regions-of-interest comprises updating region-of-interest boundaries on the association table as pixel locations receive updated labels.

23. The system of claim 17 comprising fixed function hardware of the event-driven processing unit arranged to form the clusters, form the cluster groups, and generate the regions-of-interest, wherein the computational load and processing time depend, at least in part, on the number of clusters that are determined.

24. The system of claim 17 comprising a power circuit and a power control unit arranged to provide at least one of:
dynamic voltage and frequency scaling depending on the number of events,
power gating the at least one event-driven processor when the event-driven processor is idle,
Cdyn scaling depending on the number of clusters, and
retention of states that provide events, clusters, cluster groups, regions-of-interest, or any combination of these at the at least one event-driven processor when no event is generated during a predetermined amount of time.

25. At least one non-transitory computer-readable article having instructions thereon that cause at least one event-driven computing device to operate by:
obtaining clusters of events indicating motion of image content between frames of a video sequence and at individual pixel locations;
forming cluster groups depending, at least in part, on the position of the clusters relative to each other on a grid of pixel locations forming the frames and without tracking all pixel locations forming the frames;
generating regions-of-interest comprising using the cluster groups and without tracking all pixel locations forming the frames; and
providing the regions-of-interest to applications that use segmented objects.
